(19) United States
(12) Patent Application Publication
(10) Pub. No.: US 2019/0290048 A1
(43) Pub. Date: Sep. 26, 2019

(54) Brewing Apparatus and Methods for Use

(71) Applicant: The Wayward Studio LLC, Chicago, IL (US)

(72) Inventor: Alexander E. Albanese, Chicago, IL (US)

(21) Appl. No.: 16/307,206

(22) PCT Filed: Oct. 11, 2017
(86) PCT No.: PCT/US2017/056071

§ 371 Date: Dec. 5, 2018

Related U.S. Application Data
(60) Provisional application No. 62/425,635, filed on Nov. 23, 2016.
(60) Provisional application No. 62/411,268, filed on Oct. 21, 2016.
(60) Provisional application No. 62/406,911, filed on Oct. 11, 2016.

(51) Int. Cl. A47J 31/20; A47J 31/06; A47J 31/44; A47J 31/52

(52) U.S. Cl. CPC A47J 31/20; A47J 31/0642; A47J 31/521; A47J 31/4407; A47J 31/5251; A47J 31/0689

(57) ABSTRACT

The present disclosure provides a method and apparatus for brewing coffee, tea, or the like. The apparatus uses a pod having filters on two opposed sides that is filled with ground coffee or tea and then pressed through a container of liquid. The pressing forces the liquid into one filter, through the ground coffee or tea, and out of the other filter to produce the brewed beverage.

### CROSS-REFERENCE TO RELATED APPLICATIONS

This application claims priority to (i) U.S. Provisional Application No. 62/406,911 entitled “Brewing Apparatus and Methods for Use,” filed on Oct. 11, 2016, (ii) U.S. Provisional Application No. 62/411,268 entitled “Brewing Apparatus and Methods for Use,” filed on Oct. 21, 2016, and (iii) U.S. Provisional Application No. 62/425,635 entitled “Brewing Apparatus and Methods for Use,” filed on Nov. 23, 2016, the contents of each of which are hereby incorporated by reference in their entirety.

### BACKGROUND

Unless otherwise indicated herein, the materials described in this section are not prior art to the claims in this application and are not admitted to be prior art by inclusion in this section.

Brewing coffee or tea or the like involves bringing ground roasted coffee, tea leaves or the like into contact with water to infuse the water with the flavor of the grounds or leaves. Particular brewing devices are designed to practice variations of this method such as percolators, automatic coffee makers in which hot water drips onto coffee grounds held in a filter, and French presses in which ground coffee and hot water are combined in a cylindrical vessel and left to brew for a few minutes before a circular filter is plunged through the vessel to force the grounds to the bottom of the vessel, presenting an issue of the grounds being stuck in the bottom of the vessel after brewing.

Each of these methods has various advantages and disadvantages in terms of the strength and flavor of the brewed coffee, the time that it requires to brew the coffee, and the difficulty of brewing and cleaning the brewing apparatus after use, and coffee drinkers often advocate one method over the others.

Despite the number of alternative methods and apparatus for brewing coffee which are available, there still exists a need for a process and apparatus for performing the process which produces flavorful coffee or like beverages relatively quickly with the apparatus being quick and easy to use and clean after use.

### SUMMARY

The present disclosure is therefore directed to a novel method and apparatus for brewing coffee, tea, or the like. In particular, the present disclosure is directed toward a method which may be viewed as an improvement in the French press method. In the French press method, ground coffee and hot water are combined in a vessel which is usually cylindrical and left to brew for a few minutes. A filter having dimensions complementary to the cylinder so as to fit snugly in the cylinder is fixed to a plunger which is then pushed down from the top to force the grounds in the coffee to the bottom of the vessel and brewed liquid to pass through the filter to the top. Because the ground coffee is in direct contact with the water and not filtered through paper, all the coffee oils remain in the beverage, making it stronger than coffee made by an automatic coffee machine, but leaving some sediment in the brewed coffee. Many people object to the presence of coffee ground residues in the final product.

The present disclosure broadly improves over the French press process by containing the coffee grounds or tea or the like in a closed pod which eliminates the need for a filter of the type used with a French press machine intended to filter coarse grounds, and prevents the issue of grounds being stuck at the bottom of the brewing vessel. The pod has filters both on its underside, which contacts the water and admits it into the pod as it is pressed down through a container of water, where the water is infused by coffee grounds or the like, and on its top side through which the brewed coffee passes.

The outlet filter of this pod is fine enough to prevent any substantial amount of the ground coffee residue or tea from passing with the brewed coffee or tea into the upper portion of the container. The brewed coffee or tea may then be poured from the top of the container into a separate drinking vessel. By adjusting the porosities of the input and output filters of the pod, the pressure of the liquid in the pod may be controlled thereby controlling the degree of infusion of the grounds into the liquid and the force required to plunge the pod through the liquid. In addition, the brewed coffee or tea exiting the output filter could pass through a user adjustable outlet valve.

In other embodiments of the invention, the brewing apparatus also allows a user to drink directly from the apparatus as well as to pour or selectively retain the brewed coffee or tea in the apparatus. All of these embodiments are capable of being used to produce hot beverages, or cold beverages such as iced coffee or tea, or to work with other infusion materials.

Thus, in a first embodiment, the present invention provides an apparatus including (a) a container having a closed bottom, a sidewall extending away from the closed bottom, and an open top, (b) a lid configured to be removably positioned over the open top of the container, (c) a pod having a bottom and a top spaced apart by a pod sidewall, wherein the bottom of the pod includes a first filter including a first plurality of openings, wherein the top of the pod includes a second filter including a second plurality of openings, wherein the top of the pod is removable to allow ground coffee or tea to be disposed in the pod between the first filter and the second filter, and (d) a seal coupled to an exterior of the pod, wherein an outer diameter of the seal is complementary to an inner diameter of the sidewall of the container.

In one embodiment, the open top has an inner diameter substantially equal to an inner diameter of the closed bottom.

In another embodiment, the open top has an inner diameter that is greater than an inner diameter of the closed bottom.

In another embodiment, the open top has an inner diameter that is smaller than an inner diameter of the closed bottom.

In another embodiment, the second filter includes a rigid outer frame coupled to an outer edge of the second filter and a gasket coupled to an outer edge of the rigid frame.

In another embodiment, the top of the pod is removably coupled to the pod via a threaded connection.

In another embodiment, an outer surface of the pod includes a plurality of fasteners projecting away from the outer surface, and wherein the top of the pod includes a plurality of indentations configured to receive the plurality of fasteners to thereby removably couple the top of the pod to the pod.

In another embodiment, the top of the pod is removably coupled to the pod via a press fit.

In another embodiment, the second filter is removably coupled to the top of the pod via a press fit.

In another embodiment, the seal is coupled to the exterior of the pod at the bottom of the pod.

In another embodiment, the seal is coupled to the exterior of the pod at the top of the pod.

In another embodiment, the seal comprises a first seal, wherein the first seal is coupled to the exterior of the pod at the bottom of the pod, and wherein the apparatus further comprises a second seal coupled to the exterior of the pod at the top of the pod, wherein a diameter of the second seal is complementary to the inner diameter of the sidewall of the container.

In another embodiment, the first filter has a higher porosity than the second filter, to thereby impose a pressure on a liquid as it passes through the pod. In one example of such an embodiment, the first plurality of openings of the first filter are greater in number than the second plurality of openings in the second filter. In another example, at least some of the first plurality of openings of the first filter have a greater diameter than at least some of the second plurality of openings of the second filter.

In one embodiment, the second filter is adjustable by a user to thereby adjust a porosity of the second filter.

In one embodiment, each of the first plurality of openings of the first filter has a longitudinal axis that is substantially parallel to a longitudinal axis of the container.

In one embodiment, one or more of the first plurality of openings of the first filter has a longitudinal axis that is angled with respect to a longitudinal axis of the container.

In one embodiment, a first opening of the first plurality of openings of the first filter has a longitudinal axis that is angled with respect to a longitudinal axis of a second opening of the first plurality of openings of the first filter.

In one embodiment, each opening of the first plurality of openings of the first filter is positioned on one portion of the first filter.

In one embodiment, a length of the pod sidewall separating the bottom of the pod from the top of the pod is adjustable by a user.

In one embodiment, the seal includes an outwardly extending flange and a cutout portion between the outwardly extending flange and the pod sidewall.

In one embodiment, the apparatus further comprises (e) a through-hole positioned in the lid, (f) an elongated rod positioned through the through-hole and having a first end and a second end, wherein the first end of the elongated rod is removably coupled to the top of the pod, and (g) a handle coupled to the second end of the elongated rod. In one example of such an embodiment, a cross-section of the elongated rod at the second end is less than a diameter of the through-hole in the lid. In another example of such an embodiment, the lid further includes a depression surrounding the through-hole and one or more stops configured to prevent the handle from blocking the through-hole when the handle is in a full-down position. In another example of such an embodiment, a bottom surface of the lid includes a magnet, and wherein the top of the pod includes a magnetic material configured to removably couple the bottom surface of the lid to the top of the pod. In another example of such an embodiment, the apparatus further comprises a weight having a top surface and a bottom surface, wherein the weight is removably positioned on the handle, and wherein the bottom surface of the weight includes a cutout complementary to the handle. In one example of such an embodiment, the weight comprises a first weight, the apparatus further comprising a second weight having a top surface and a bottom surface, wherein the second weight is removably positioned on the top surface of the first weight, wherein the bottom surface of the second weight is complementary to the top surface of the first weight.

In one embodiment, the apparatus further comprises a brake filter having one or more openings removably positioned adjacent the second filter at the top of the pod. In one example of such an embodiment, at least one of the one or more openings of the brake filter are adjustable by a user.

In one embodiment, the top of the pod is configured to be removably attached to a bottom surface of the lid prior to use, and wherein the apparatus further includes a release mechanism configured to release the pod from the bottom surface of the lid during use.

In one embodiment, the apparatus further comprises a funnel removably coupled to the pod sidewall.

In one embodiment, the apparatus further comprises a disposable cartridge positioned in the pod, wherein the disposable cartridge includes ground coffee or tea. In one example of such an embodiment, the disposable cartridge has a cross-section at a top of the cartridge that is wider than a cross-section at a bottom of the cartridge. In another example of such an embodiment, the disposable cartridge has a cross-section at a bottom of the cartridge that is wider than a cross-section at a top of the cartridge. In another example of such an embodiment, the disposable cartridge includes an inlet filter positioned at a bottom of the cartridge and an outlet filter positioned at the top of the cartridge. In one example of such an example, the inlet filter of the disposable cartridge has a higher porosity than the outlet filter of the disposable cartridge, to thereby impose a pressure on a liquid as it passes through the disposable cartridge. In another example of such an embodiment, the apparatus further comprises a membrane positioned between the inlet filter of the disposable cartridge and the outlet filter of the disposable cartridge.

In one embodiment, the apparatus further comprises a base removably coupled to the closed bottom of the container, wherein the base includes one or more force sensors. In one example of such an embodiment, the base includes a display to provide a visual display of an amount of force applied to the container. In another example of such an embodiment, the base includes a wireless communication interface configured to transmit a determined amount of force applied to the container to a computing device. In another example of such an embodiment, the base includes a timer.

In one embodiment, the apparatus further comprises a heating base removably coupled to the closed bottom of the container, wherein the heating base is configured to heat a liquid positioned in the container.

In yet another embodiment, the disclosure provides a method comprising (a) filling the container of the apparatus of any one of the embodiments described above with a liquid, (b) positioning ground coffee or tea in the pod, (c) positioning the pod in the open top, (d) positioning the lid over the open top, and (e) moving the pod through the liquid until the pod is positioned on the closed bottom of the container, such that the liquid is forced through the first filter, through the ground coffee or tea, and out of the second filter, to produce brewed coffee or tea in the volume of the container above the pod.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 illustrates a cross-section view of a brewing apparatus, according to an example embodiment.

FIG. 2 illustrates a perspective view of a pod and seal of the brewing apparatus of FIG. 1, according to an example embodiment.

FIG. 3 illustrates a side view of the pod and seal of the brewing apparatus of FIG. 1, according to an example embodiment.

FIG. 4 illustrates a cross-section view of the pod and seal of the brewing apparatus of FIG. 1, according to an example embodiment.

FIG. 5 illustrates a top view of the pod and seal of the brewing apparatus of FIG. 1, according to an example embodiment.

FIG. 6 illustrates a bottom perspective view of the pod and seal of the brewing apparatus of FIG. 1, according to an example embodiment.

FIG. 7 illustrates a bottom view of the pod and seal of the brewing apparatus of FIG. 1, according to an example embodiment.

FIG. 8 illustrates a top view of a second filter of the brewing apparatus of FIG. 1, according to an example embodiment.

FIG. 9 illustrates a bottom perspective view of the second filter of the brewing apparatus of FIG. 1, according to an example embodiment.

FIG. 10 illustrates a side view of the second filter of the brewing apparatus of FIG. 1, according to an example embodiment.

FIG. 11 illustrates a cross-section view of the second filter positioned in the top of the pod of the brewing apparatus of FIG. 1, according to an example embodiment.

FIG. 12 illustrates a side view of a pod of another brewing apparatus, according to an example embodiment.

FIG. 13 illustrates a top perspective view of the pod of FIG. 12, according to an example embodiment.

FIG. 14 illustrates a top view of the pod of FIG. 12, according to an example embodiment.

FIG. 15 illustrates a bottom perspective view of the pod of FIG. 12, according to an example embodiment.

FIG. 16 illustrates a side view of another pod of a brewing apparatus, according to an example embodiment.

FIG. 17 illustrates a bottom view of another example pod, according to an example embodiment.

FIG. 18 illustrates a back view of an example brewing apparatus, according to an example embodiment.

FIG. 19 illustrates a perspective view of the brewing apparatus of FIG. 18, according to an example embodiment.

FIG. 20 illustrates a top view of the brewing apparatus of FIG. 18, according to an example embodiment.

FIG. 21 illustrates a side cross-section view of the brewing apparatus of FIG. 18, according to an example embodiment.

FIG. 32 illustrates a side view of another brewing apparatus, according to an example embodiment.

FIG. 23 illustrates a side cross-section view of the brewing apparatus of FIG. 22, according to an example embodiment.

FIG. 24 illustrates a side view of a funnel of a brewing apparatus, according to an example embodiment.

FIG. 25 illustrates a single chamber disposable cartridge, according to an example embodiment.

FIG. 26 illustrates another single chamber disposable cartridge, according to an example embodiment.

FIG. 27 illustrates another single chamber disposable cartridge, according to an example embodiment.

FIG. 28 a multi-chamber disposable cartridge, according to an example embodiment.

FIG. 29 illustrates a base of a brewing apparatus, according to an example embodiment.

FIG. 30 illustrates an induction heating base of a brewing apparatus, according to an example embodiment.

FIG. 31 illustrates a physical circuit heating base of a brewing apparatus, according to an example embodiment.

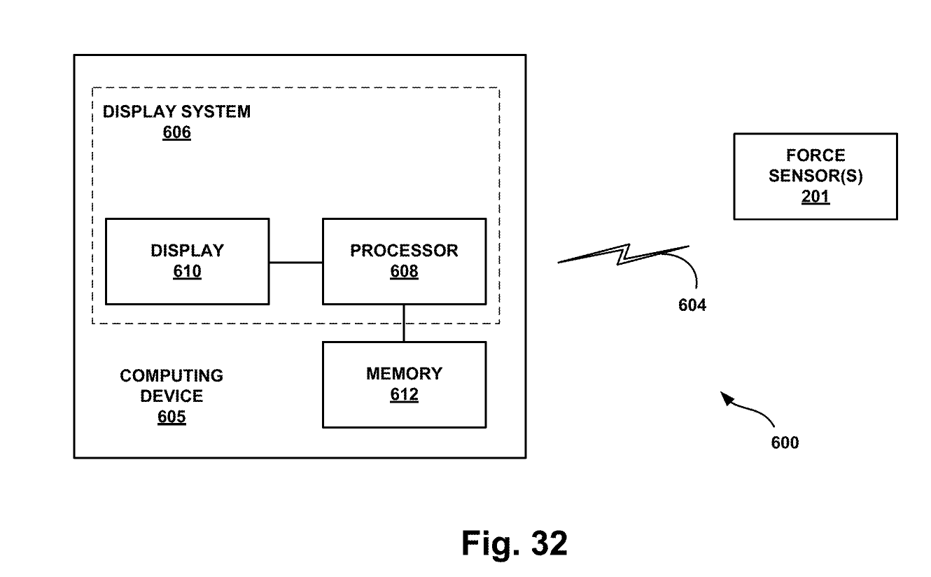

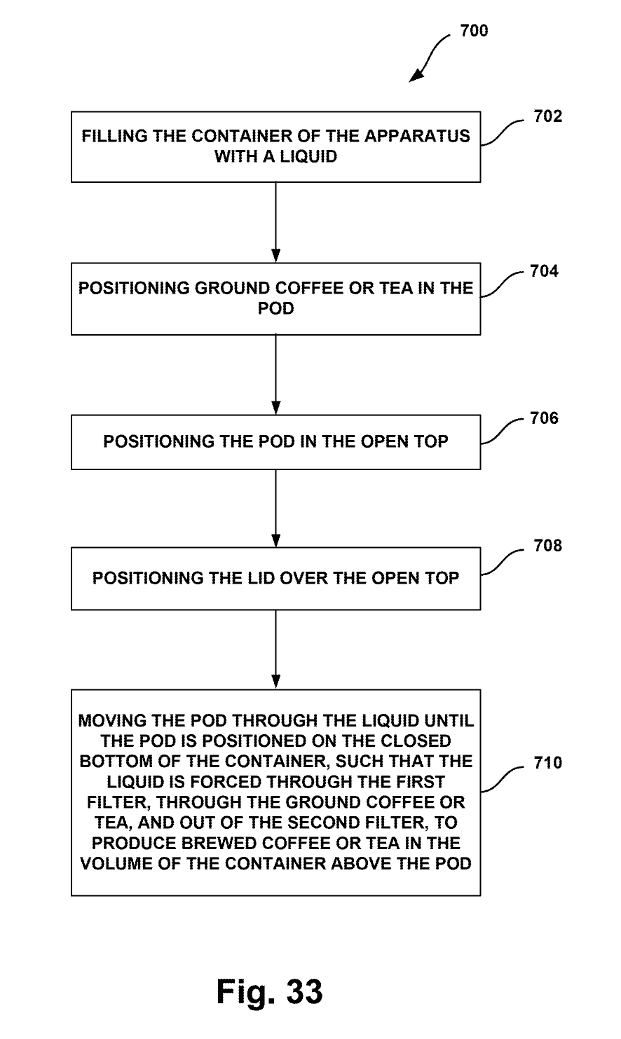

FIG. 32 is a schematic drawing of a computer network infrastructure, according to an example embodiment.

FIG. 33 is a flowchart illustrating an example method according to an example embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

As used herein, with respect to measurements, “about” means +/−5%.

As used herein, “substantially” means +/−5%.

As used herein, “coupled” means associated directly as well as indirectly. For example, a member A may be directly associated with a member B, or may be indirectly associated therewith, e.g., via another member C. It will be understood that not all relationships among the various disclosed elements are necessarily represented.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The preferred embodiments of the invention described herein are intended to brew coffee and are described as such. However, the same structures or minor variations thereon could be used to brew tea leaves, herbs, or the like and use of the term coffee should not be taken as restrictive of the scope of the invention. Additionally, while the preferred embodiments are described as brewing heated beverages, in general they are capable of making cold beverages such as iced tea, cold brewed coffee, or the like.

In the disclosed embodiments the devices including the liquid containers are generally cylindrical but could be square or other configurations in cross-section.

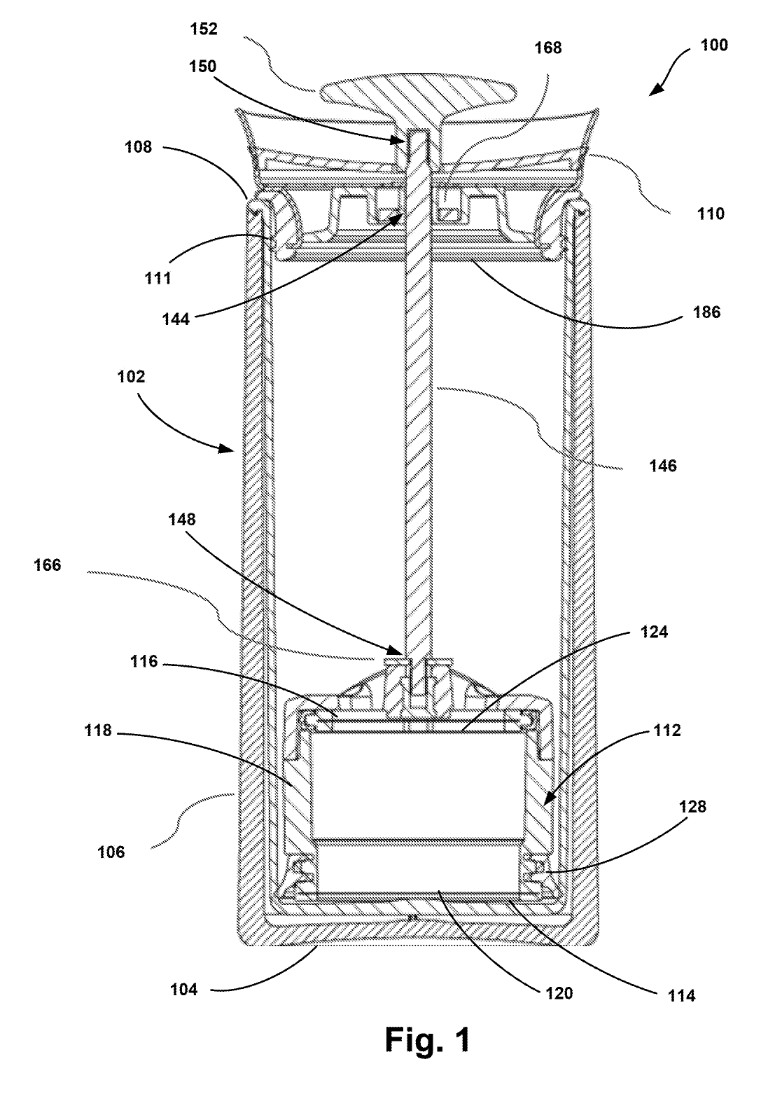

With reference to the Figures, FIG. 1 illustrates a cross-section view an example brewing apparatus 100. The apparatus 100 includes a container 102 having a closed bottom 104, a sidewall 106 extending away from the closed bottom 104, and an open top 108. The apparatus also includes a lid 110 configured to be removably positioned over the open top 108 of the container 102. The lid 110 may include a seal 111 to secure the lid 110 over the top 108 of the container 102. The apparatus also includes a pod 112 having a bottom 114 and a top 116 spaced apart by a pod sidewall 118. The bottom 114 of the pod 112 includes a first filter 120 including a first plurality of openings 122, and the top 116 of the pod 112 includes a second filter 124 including a second plurality of openings 126. The top 116 of the pod 112 is removable to allow ground coffee or tea to be disposed in the pod 112 between the first filter 120 and the second filter 124. The apparatus 100 also includes a seal 128 coupled to an exterior of the pod 112, wherein a diameter of the seal 128 is complementary to an inner diameter of the sidewall 106 of the container 102.

In one example, the open top 108 has an inner diameter substantially equal to an inner diameter of the closed bottom 104. In such an embodiment, the sidewalls 106 are all substantially parallel to one another. In another example, the open top 108 has an inner diameter that is greater than an inner diameter of the closed bottom 104. In yet another example, the open top 108 has an inner diameter that is smaller than an inner diameter of the closed bottom 104.

As illustrated in FIG. 1, each of the elements described above may all be joined together into a unitary body with threaded connections, press fits, keyed connections or the like. The outer diameters of the pod 112 may be cylindrical with a diameter complementary to the inner diameter of the container 102. Thus the pod 112 may be pressed into the container 102 through its open top 108 and snugly fit within the inner diameter of the container 102. Previous to that, ground coffee or tea may be inserted into the pod 112 which is closed off by a screw lid or press fit. Water or other liquids are placed within the container 102, or, for hot beverages, the liquid may be heated within the container, preferably by electrical resistance heating elements or by microwave energy.

The proportions of the water and coffee are a function of the strength of the brew that it is desired. The water is typically boiled so that when it is poured into the container 102, which is typically cooler, its temperature has dropped to the range of about 170 to 200 degrees F. This is typically considered to be the desired brewing temperature for coffee in a French press.

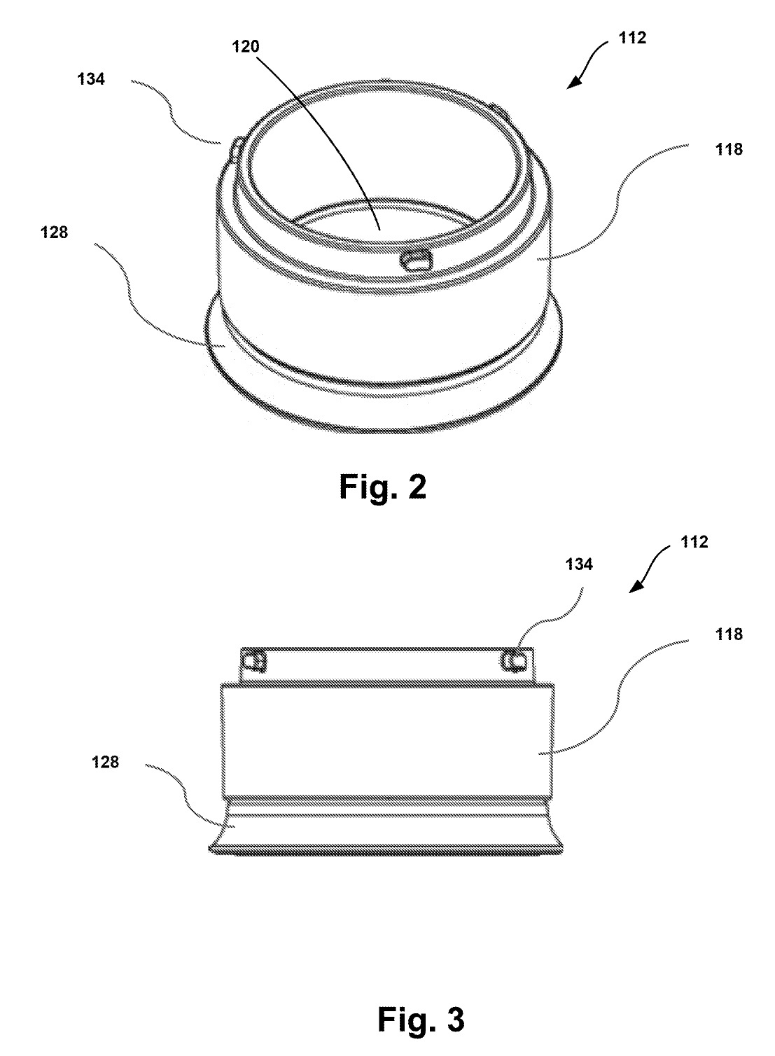

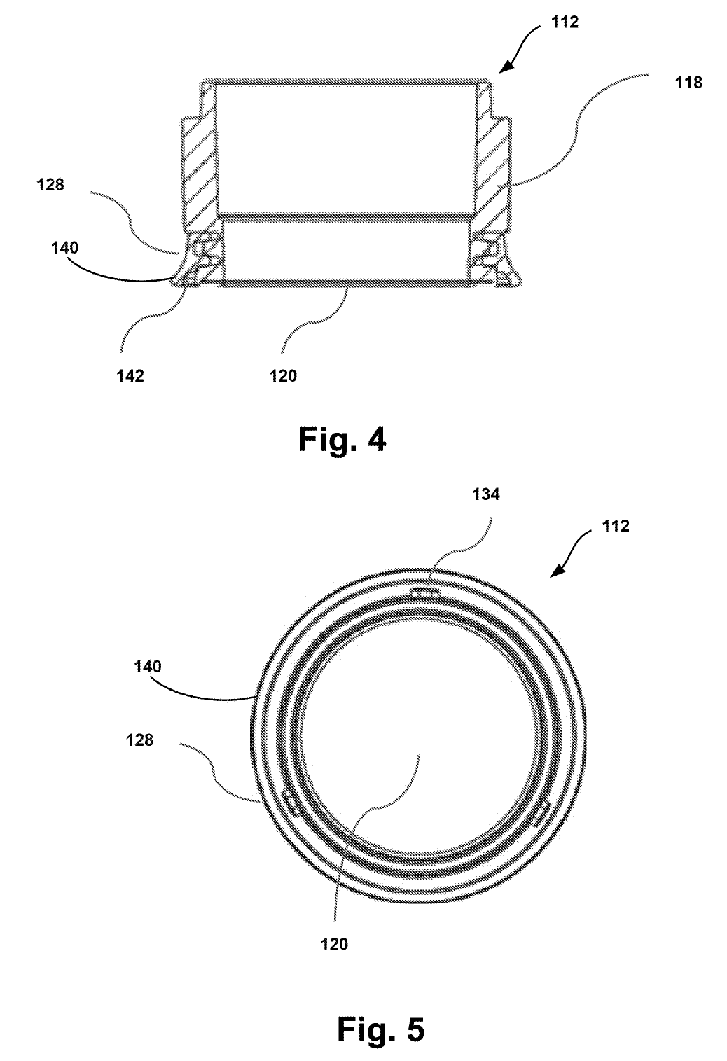

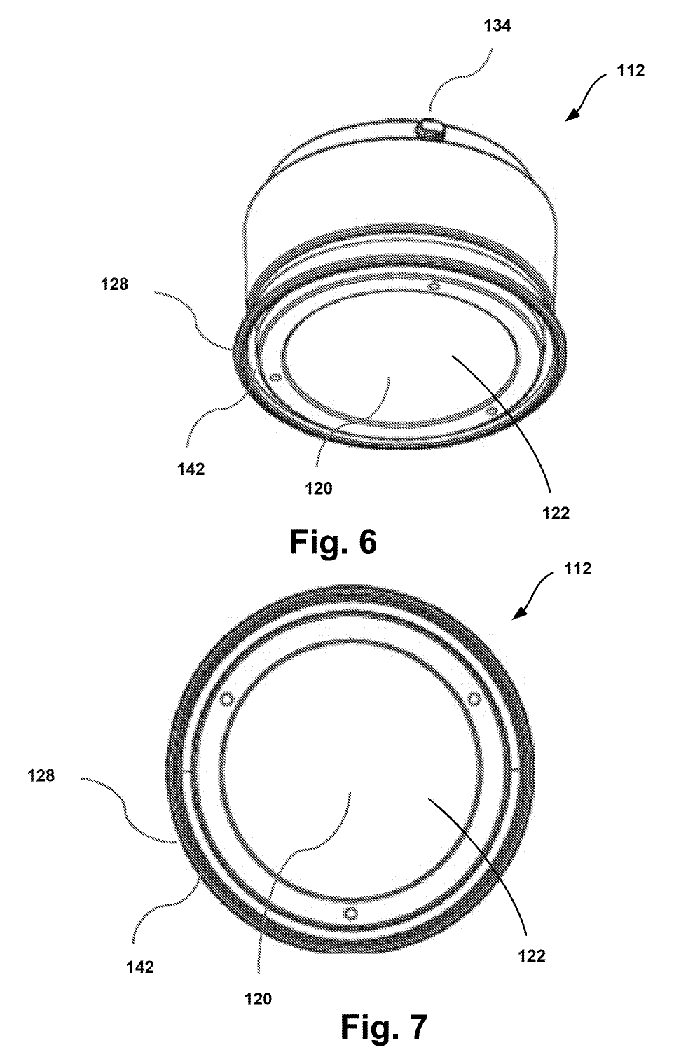

As described above, and as shown in FIGS. 2-7, the apparatus 100 includes a pod 112 in which some soluble material could be disposed and contained, such that water can pass through the pod 112 as it was moved through the container 102 and then exit the pod 112 into a separate final volume defined by the position of the pod 112 in the container 102. To keep the final volume separate from the initial volume of the container 102, the seal 128 is required. The seal 128 should both be effective and not cause too much friction or else the apparatus 100 would require extra force to operate without benefit to extraction. The pod 112 itself should also be easy to open and close to allow dispensing and removal of a soluble substance, but also secure enough to keep the pod 112 from opening during operation of the apparatus 100 or removal of the pod 112 after use as significant drag forces are applied due to friction between the seal 128 and container 102 during both operation of the apparatus 100 and removal of the pod 112 after use.

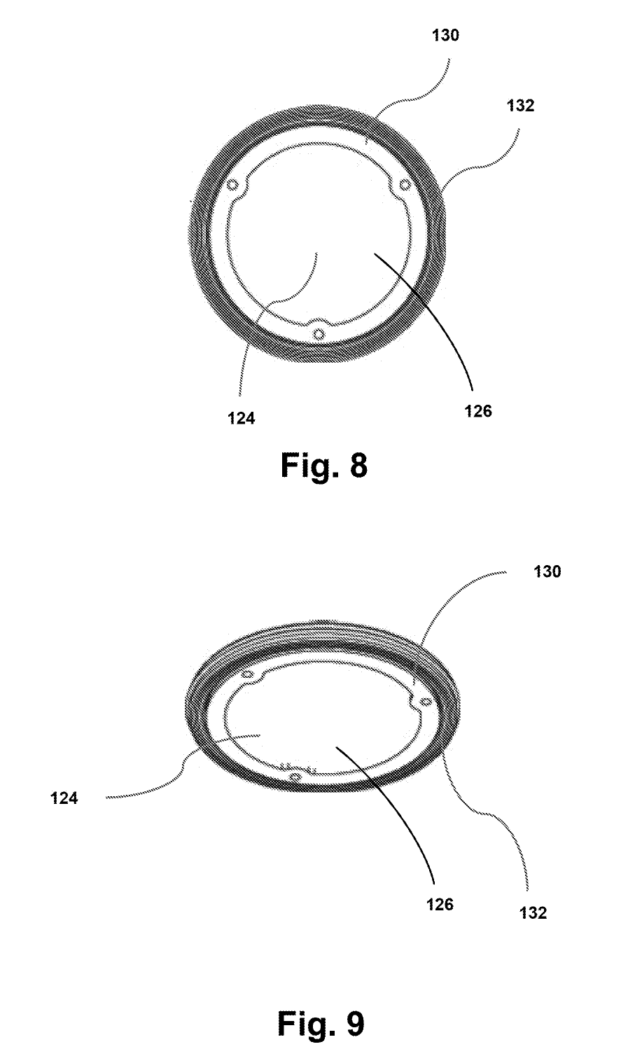

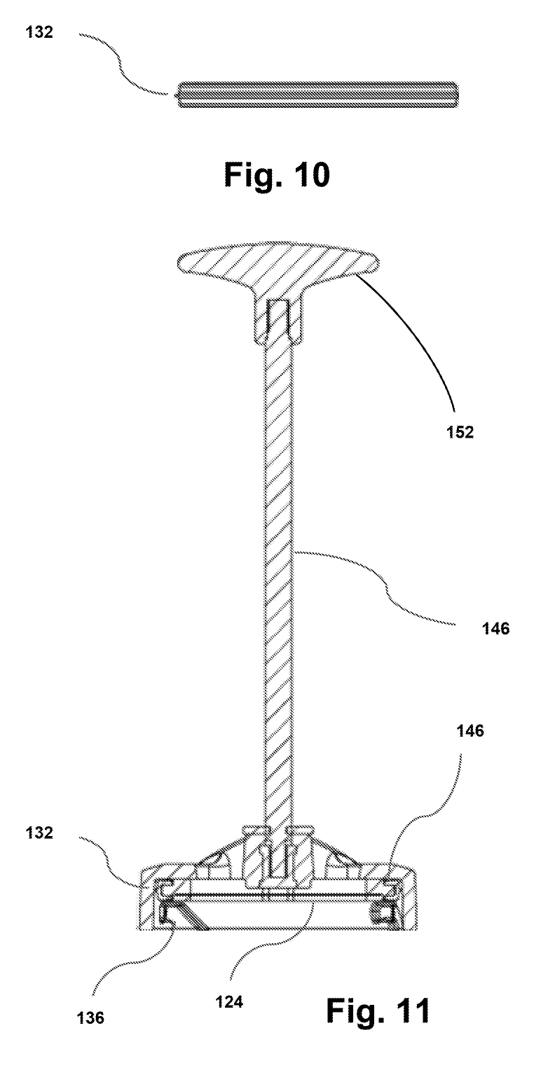

An integral part of allowing for the easy opening and closing of a solute containing pod 112 and the separation of a brewed liquid from the remaining solute is the design of the top 116 of the pod 112 including the removable second filter 124 disclosed herein. In one example, as shown in FIGS. 8-11, the second filter 124 includes a rigid outer frame 130 coupled to an outer edge of the second filter 124 and a gasket 132 coupled to an outer edge of the rigid frame 130. In one example, the top 116 of the pod 112 is removably coupled to the pod 112 via a threaded connection. In another example, the top 116 of the pod 112 is removably coupled to the pod 112 via a press fit. In yet another example, an outer surface of the pod 112 includes a plurality of fasteners 134 projecting away from the outer surface, and the top 116 of the pod 112 includes a plurality of indentations 136 configured to receive the plurality of fasteners 134 to thereby removably couple the top 116 of the pod 112 to the pod 112. In particular, the plurality of indentations 136 may comprise an L-shaped channel into which the plurality of fasteners 134 are positioned, and then the top 116 of the pod 112 can be rotated with respect to the bottom 114 of the pod 112 to thereby secure the top 116 of the pod 112 to the rest of the pod 112.

In such an example, the gasket 132 of the second filter 124 works in combination with the plurality of fasteners 134 on the pod and the plurality of indentations 136 on the top 116 of the pod 112 to provide enough friction for the pod 112 to securely close by compressing the gasket 132 without causing excessive resistance. In this way, the gasket 132 and its sealing surface features serve both to seal the pod 112 to the top 116 of the pod 112 to prevent brewed liquids under pressure escaping out the sides of the pod 112 and thus bypassing the second filter 124, and to act as a spring to provide the force necessary to firmly attach the pod 112 to the top 116 of the pod 112. By fixing the second filter 124 in a rigid frame 130 the soft gasket 132 also allows the second filter 124 to remain in place during operation and setup of the apparatus 100 simply with friction, thus allowing the user to remove the second filter 124 for cleaning or to replace it with a new filter or alternative filters. This combination of features results in an second filter 124 that serves not only as an easily removable filter, but also as an integral part of the pod 112 itself, without which the pod 112 would not be able to close properly and remain closed during operation, or seal properly.

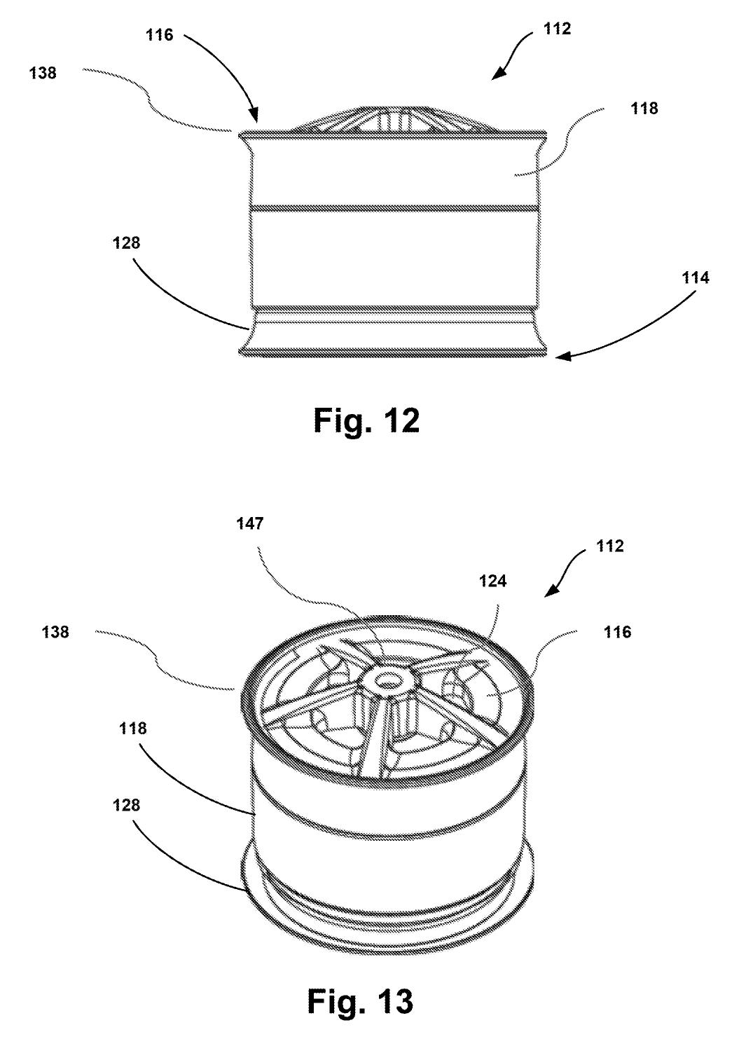

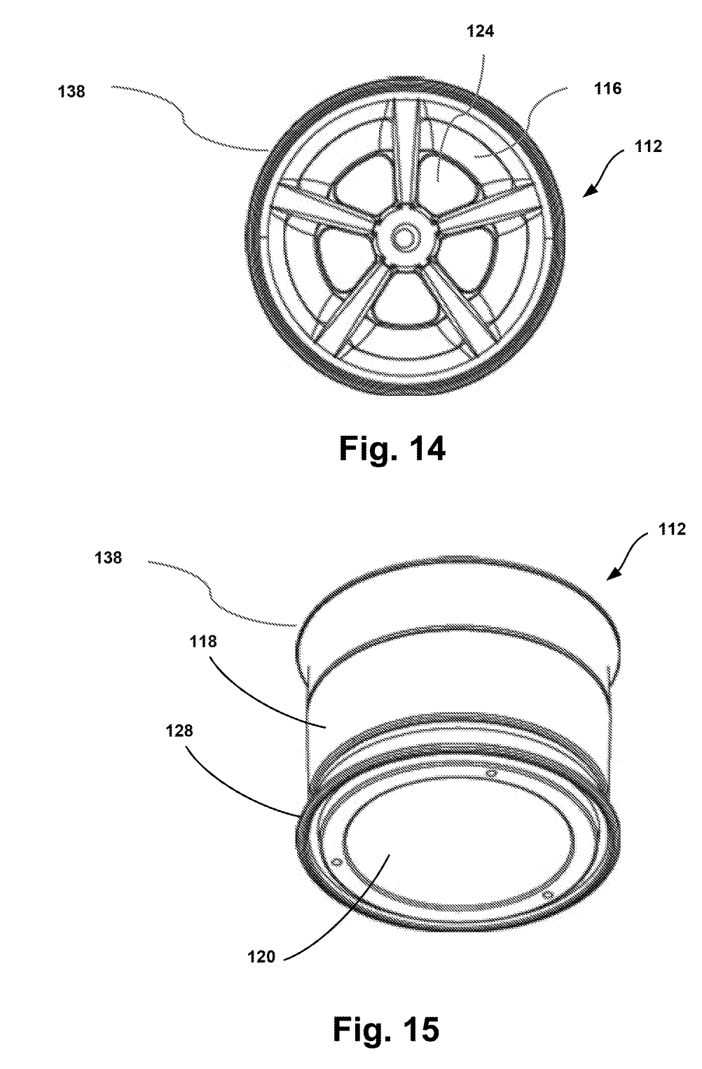

The pod 112 may take a variety of forms. In one example, as shown in FIGS. 1-7, the seal 128 is coupled to the exterior of the pod 112 at the bottom 114 of the pod 112. In another example, the seal 128 is coupled to the exterior of the pod 112 at the top 116 of the pod 112. In yet another example, as shown in FIGS. 12-15, the seal 128 comprises a first seal. In such an example, the first seal 128 is coupled to the exterior of the pod at the bottom 114 of the pod 112, and the apparatus 100 further comprises a second seal 138 coupled to the exterior of the pod 112 at the top 116 of the pod 112. Similar to the first seal 128, an outer diameter of the second seal 138 is complementary to the inner diameter of the sidewall 106 of the container 102.

As shown in FIGS. 12-15, the second seal 138 serves both as a main seal during brewing and for maintaining alignment of the pod 112 in combination with the first seal 128 of the apparatus 100. The second seal 138 also allows the pod sidewalls 118 to remain dry during use, and in combination with the concave contour of the top 116 of the pod 112, encourage residual beverage to drain back into the pod 112 through the second filter 124, thus preventing mess from accumulated liquid being trapped on top of the first seal 128 and pulled out of the container 102 during disassembly. The second seal 138 can also be used instead of the traditional first seal 128 as described above to allow a less robust attachment of the traditional pod 112 to the top of the pod 114, all independent of embodiment (e.g., can be applied to any version of the apparatus 100 described herein).

Additionally, the size of the second plurality of openings 122 of the second filter 124 can be varied to tune back-pressure and resulting speed of the pod 112 dropping through the container 102 under the power of gravity, and the second seal 138 can be reduced to an incomplete radius (such as small protrusions at only three points separated by 120 degrees), to allow contact with the sidewalls 106 of the container 102, but not to seal completely, thus reducing friction during and after brewing which reduces required mass, and allowing the first seal 128 to better collapse after brewing. Such a configuration may aid in the pod 112 not only descending under gravity power, but coming back out of the container 102 under power of gravity simply by turning the container 102 upside down. This is important, as once the pod 112 is full of wet coffee grounds or the like, and particularly with finer filters in place, such as a brake filter or paper filters, a partial vacuum is formed that may prevent the pod 112 from being extracted easily.

When fully assembled, the pod 112 works to contain a soluble material and separate a brewed liquid from an extracting liquid with the aid of the seal 128, the first filter 120, and the second filter 124. The first filter 120 prevents excessive amounts of soluble material exiting the pod 112 during assembly and operation, and afterwards as well, while also allowing liquid in. The size of the first filter 120 and/or the second filter 124 may be controlled so as to set the pressure experienced by the liquid as it passes through the pod 112. The second filter 124 should be fine enough to prevent any appreciable quantity of the coffee grounds in the pod 112 from passing through with the brewed beverage. In one example, the first filter 120 has a higher porosity than the second filter 124, to thereby impose a pressure on a liquid as it passes through the pod. In such an example, the first plurality of openings 122 of the first filter 120 may be greater in number than the second plurality 126 of openings in the second filter 124. In another example, at least some of the first plurality of openings 122 of the first filter 120 have a greater diameter than at least some of the second plurality of openings 126 of the second filter 124.

The first plurality of openings 122 of the first filter 120 can be varied in size to allow for adjustments to back-pressure and pressure inside the pod 112, and varied in orientation to allow for control of water flow. For example, typically the first plurality of openings 122 are channels oriented in the direction of operation of the container 102, and all channels are oriented in the same direction. In such an example, each of the first plurality of openings 122 of the first filter 120 has a longitudinal axis that is substantially parallel to a longitudinal axis of the container 102. However, these channels can be oriented at an angle to the operation of the apparatus 100 to cause turbulence and increase agitation of the soluble compound contained in the pod 112. In such an example, one or more of the first plurality of openings 122 of the first filter 120 has a longitudinal axis that is angled with respect to a longitudinal axis of the container 102. Additionally or alternatively, these channels can be oriented at an angle with respect to each other to further increase agitation in the pod 112. In such an example, a first opening of the first plurality of openings 122 of the first filter 120 has a longitudinal axis that is angled with respect to a longitudinal axis of a second opening of the first plurality of openings 122 of the first filter 120. In yet another example, each opening of the first plurality of openings 122 of the first filter 120is positioned on one portion of the first filter 120. In one particular example, only one half of the first filter 120 includes openings, and the other half is substantially solid. Other arrangements are possible as well, such as one quarter, one third, etc. Such an embodiment may further provide cause turbulence and increase agitation of the soluble compound contained in the pod 112.

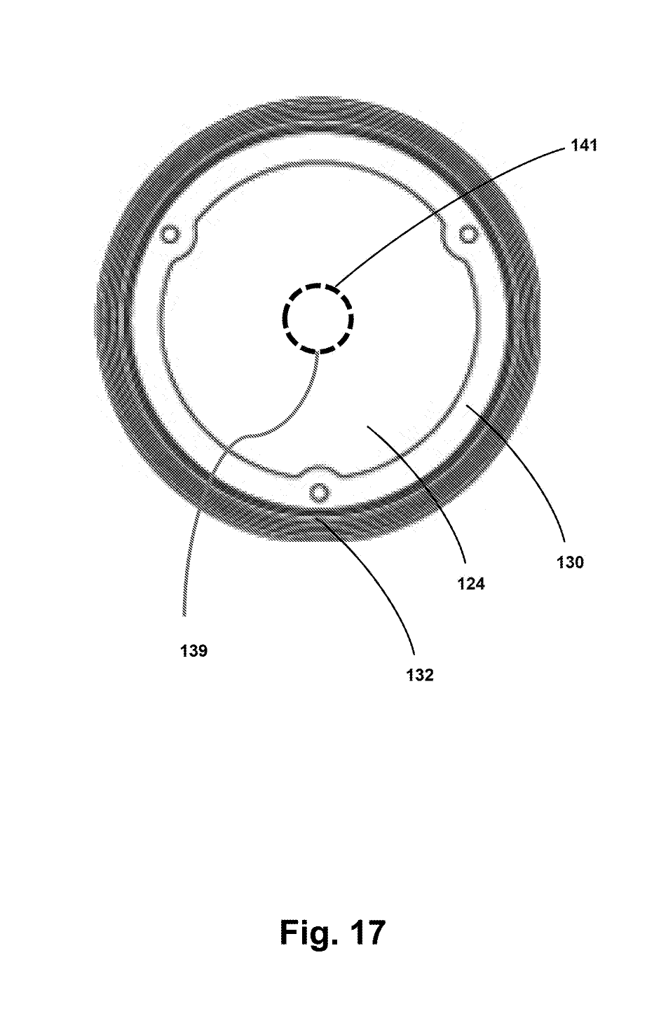

In one embodiment, as shown in FIG. 17, the apparatus 100 may further include a brake filter 139 having one or more openings 141 removably positioned adjacent the second filter 124 at the top 116 of the pod 112. The brake filter 139 can serve to control the drop of the pod 112 through the container 102 under the force of gravity, or any means of applying force, including traditional hand operation as described in additional detail below, by allowing tuning of the hydrodynamic drag based on the chose porosity, pore size, total pores, etc., and any combination thereof

In practice, by varying the size of the one or more openings 141, the brake filter 139 can act as a hydraulic damper, slowing the movement of the pod 112 and resulting flow of beverage out of the pod 112 under a given applied force, and allowing tuning of extraction/residence time (how long the extracting liquid is in contact with the substance to be extracted) simply by changing between a plurality of brake filters 139. This may also increase pressure inside the pod 112, which is known to aid in the extraction of beverages like coffee, adding a further advantage beyond simply slowing the speed of the pod 112 to increase contact time.

Additionally, rather than being single opening, the one or more openings 141 can consist of an area of the brake filter 139 that has many openings, such as restricting the surface area to which an etching process is applied to an otherwise standard substrate to create a variable opening consisting of many smaller openings.

In yet another example, at least one of the one or more openings 141 of the brake filter 139 are adjustable by a user. For example, one or more of the one or more openings 141 may be covered by a user prior to use. In another example, the brake filter 139 comprises a single opening that has a diameter that is adjustable by the user. Other examples are possible as well.

In addition to helping to control the descent of the pod 112 under a force of gravity by slowing descent under the force of weights heavy enough to complete descent (often due to non-linear resistance of the apparatus in brewing, much more force is required towards the end of a transit than at the beginning as grounds or the like soak up water, expand, and further restrict flow and fines clog outlet filters), the brake filter 139 can also serve to control human factors when the substance to be extracted may not resist water flow enough to prevent a user pressing too quickly. The same result may be achieved with mechanical friction or the like, but it would not be as easy to tune or change this as with the brake filter 139, owing to its shared design with the first filter 120 described above, which allows it to be easily removed. The brake filter 139 is also a small and relatively inexpensive, making it an ideal part to have multiple versions of to be routinely swapped in and out.

Further, small openings like these in espresso machines are known to produce a “crema”, a desirable foam resulting from extracting coffee under pressure, which may be an additional advantage of these brake filters restricting flow. This is sometimes called a “false crema”, but it still adds a desirable aspect to the final brewed beverage.

In addition to varying the channel orientation and opening size of the first plurality of openings 122 of the first filter 120, the pod sidewalls 118 can be varied in height to change the volume of the pod 112 while remaining completely compatible with the remaining components of the apparatus 100. This allows the pod 112 to be tuned to hold more or less solute, and it allows for larger volumes to contain the same amount of solute as smaller pod bodies, thus increasing extraction by providing more extracting liquid (and lower relative concentrations of dissolved solids) in the pod interior volume, and increasing agitation by allowing the same dosing of solute to extracting liquid to be used with a larger pod, thus allowing the solute contained therein to move more freely. In one example, the length of the pod sidewall 118 separating the bottom 114 of the pod 112 from the top 116 of the pod 112 is adjustable by a user. In such an example, the pod 112 may include a first portion telescopically connected to a second portion, such that the user can extend the length of the pod sidewall 118 by move the first portion with respect to the second portion. In another example, the pod 112 may include a first portion connected to a second portion via a threaded connection, such that the user can extend the length of the pod sidewall 118 by rotating the first portion with respect to the second portion. Other arrangements are possible as well.

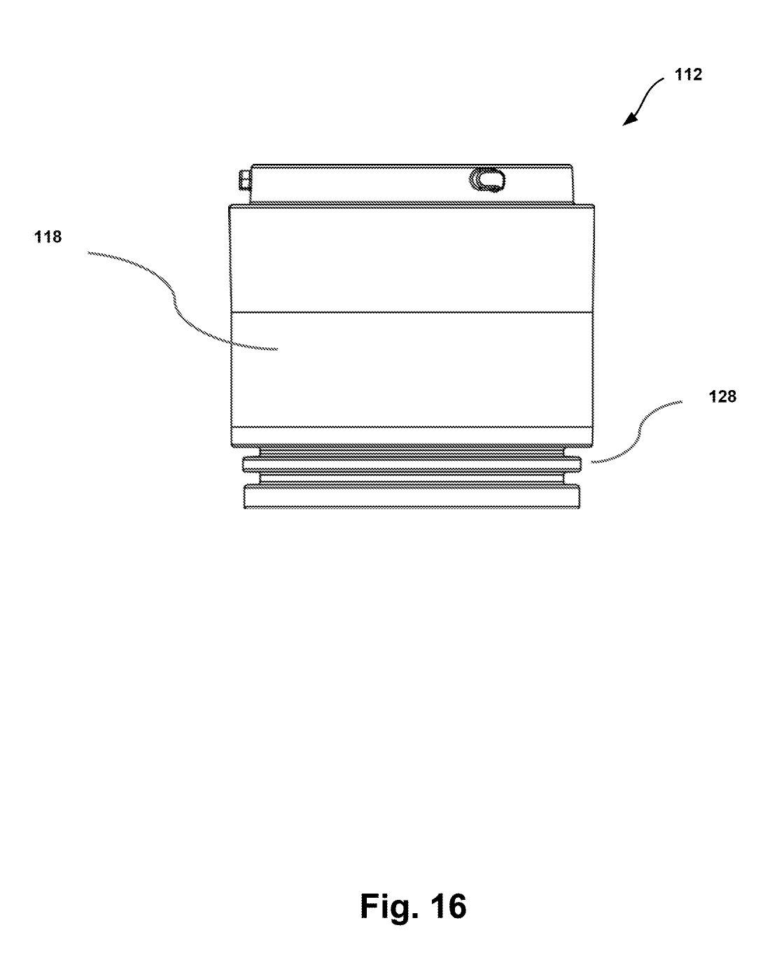

FIG. 16 shows another version of the pod 112 as previously described, with increased height in the pod sidewall 18. Height can be varied to any desired height within basic limitations relative to the container 102 height and would typically be sized relative to reasonable coffee-to-water ratios except when extra void space is desired or other atypical loading requirements exist, such as to create agitation by not having coffee tightly packed (i.e., by leaving a larger void space in the loaded pod to allow coffee grounds to move freely as water enters through the pod 112, possibly in combination with asymmetrical pod filter inlets to increase agitation.

Height can be varied while maintaining other dimensions, such as diameter and standard locking and attachment features, to maintain compatibility with standard pod parts, such as the main seal and pod top, as well as the standard container 102 and other parts of the apparatus 100, while also allowing new fluid dynamics inside the larger pod interior volume and allowing a greater total capacity for coffee or other substances to be disposed into the pod 112.

Similarly, the pod sidewall 118 can be shortened to provide a more compact pod 112, increasing total yield of brewed beverage from the apparatus 100 and again changing fluid dynamics, possibly in combination with altered inlet and outlet designs for the pod body and pod top 116, including but not limited alternate filter designs. This can alter fluid dynamics and extraction of coffee or other substances in the pod 112, potentially by providing a more compact mass of coffee or similar substance, such as in espresso machines where coffee is compacted into a small volume in their porta-filters.

To improve sealing in cases of imperfect inner diameter tolerances of the container 102 while preventing excessive resistance due to friction between seal 128 and the sidewall 106 of the container 102, the seal 128 may include an outwardly extending flange 140 and a cutout portion 142 between the outwardly extending flange 140 and the pod sidewall 118. The cutout portion 142 between the inner wall of seal 128 and the pod sidewall 118 allows the pressure generated during operation of the apparatus 100 to push the seal 128 outwards and into the sidewall 106 of the container 102, while also allowing it to alternatively collapse. This may be advantageous in allowing the seal 128 to maintain a watertight seal by expanding with the aid of hydraulic pressure as it passes over smaller inner diameters and to not jam during operation by contracting as it passes over larger diameters, both issues due to imperfect tolerances. The cutout portion 142 also allows the manufacture of containers 102 with a non-zero interior draft by allowing the seal 128 to collapse as it encounters during operation of the apparatus 100 increasingly smaller inner diameters near the closed bottom 104 of the container 102. This may be particularly useful for a container 102 made with tooling requiring a non-zero draft for proper release of the tooling.

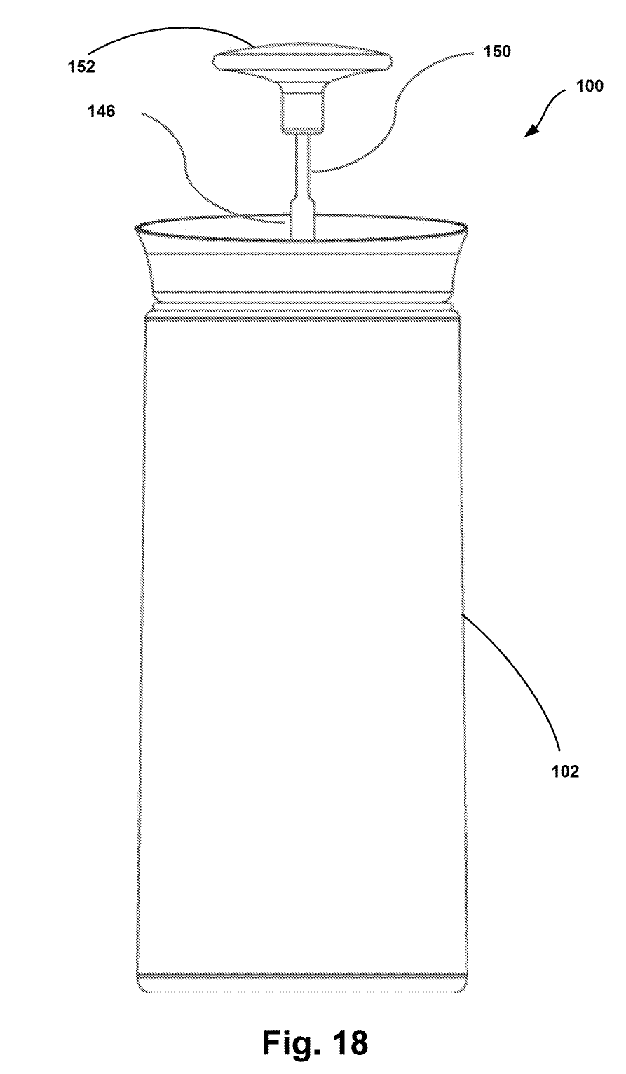

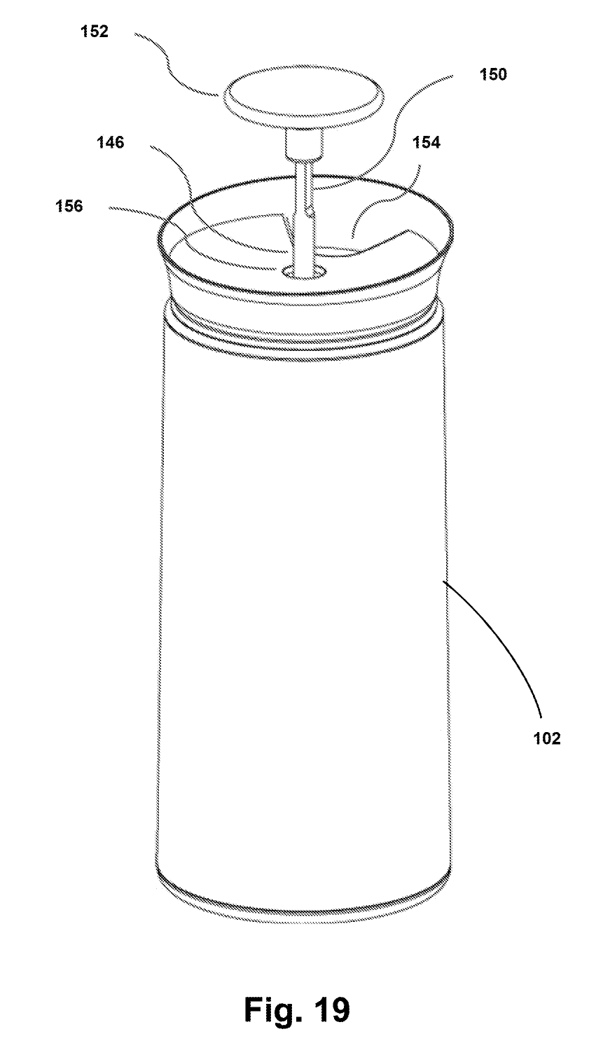

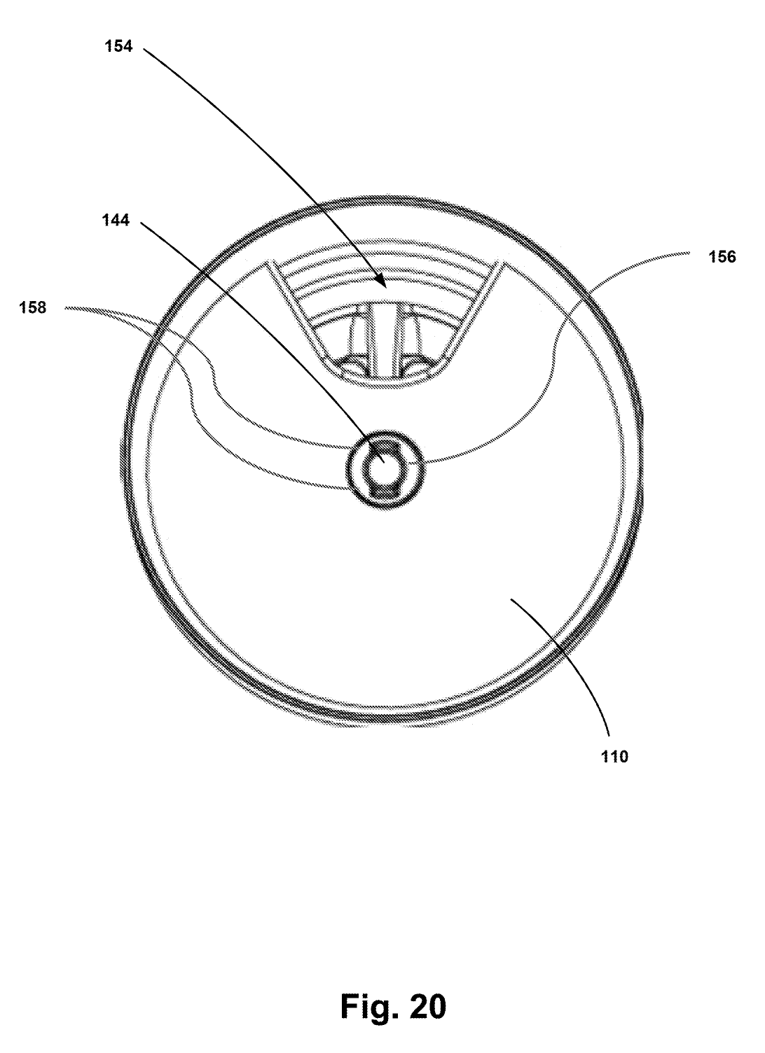

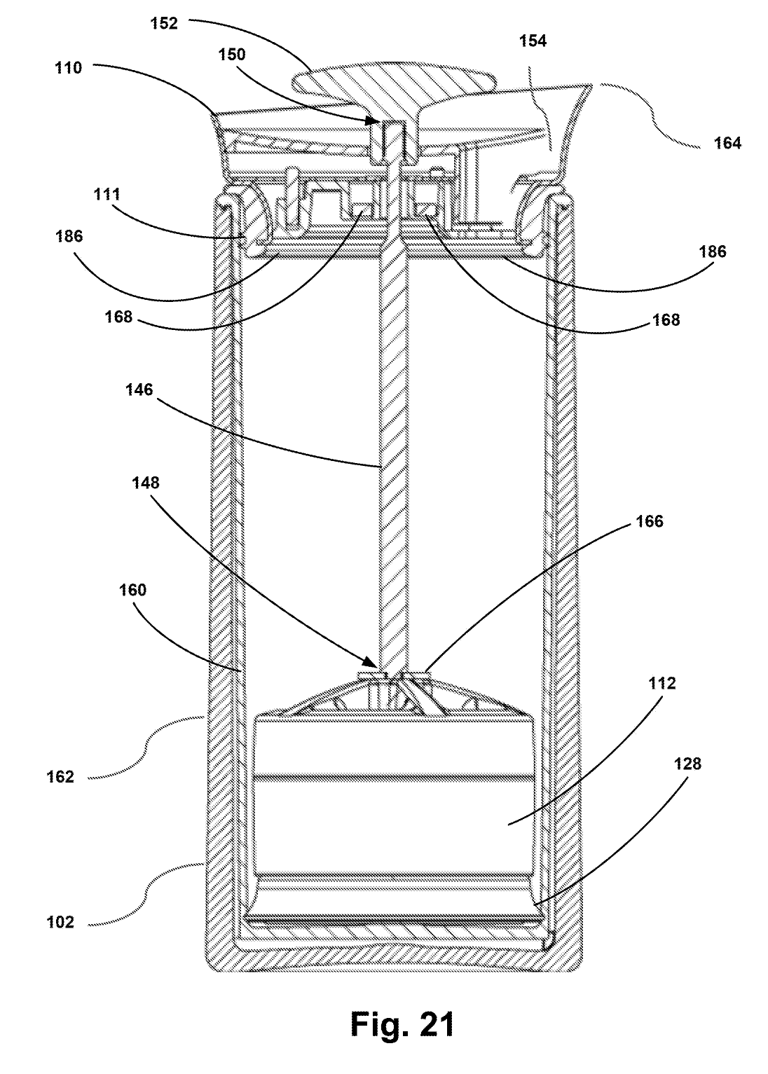

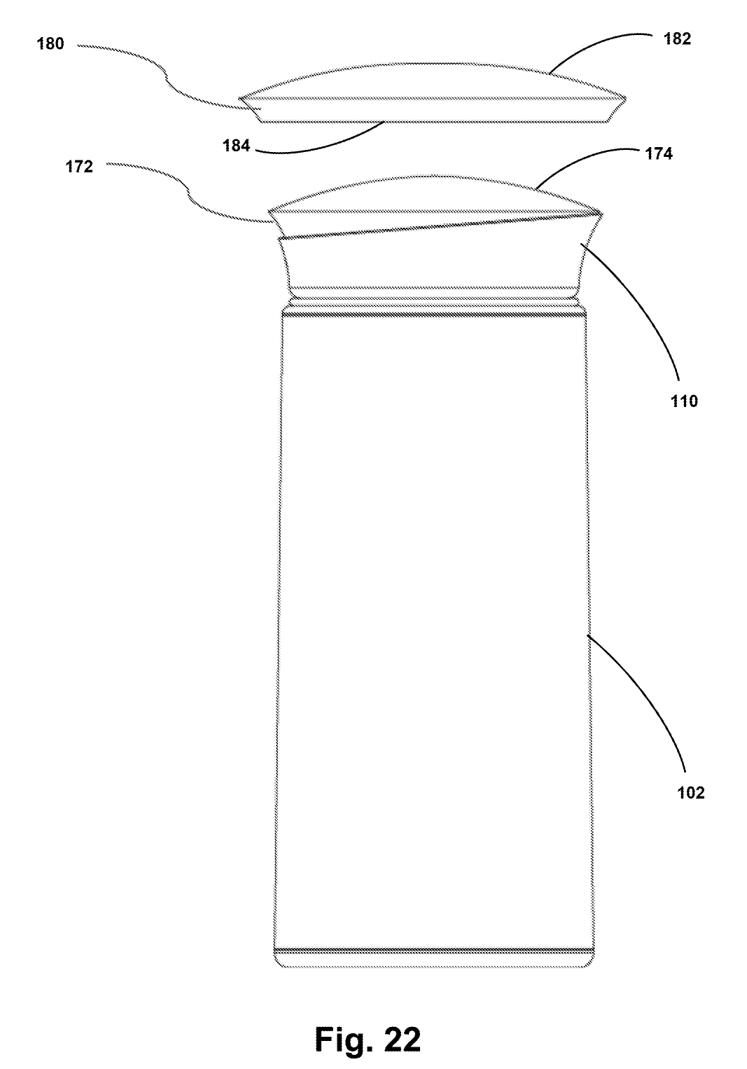

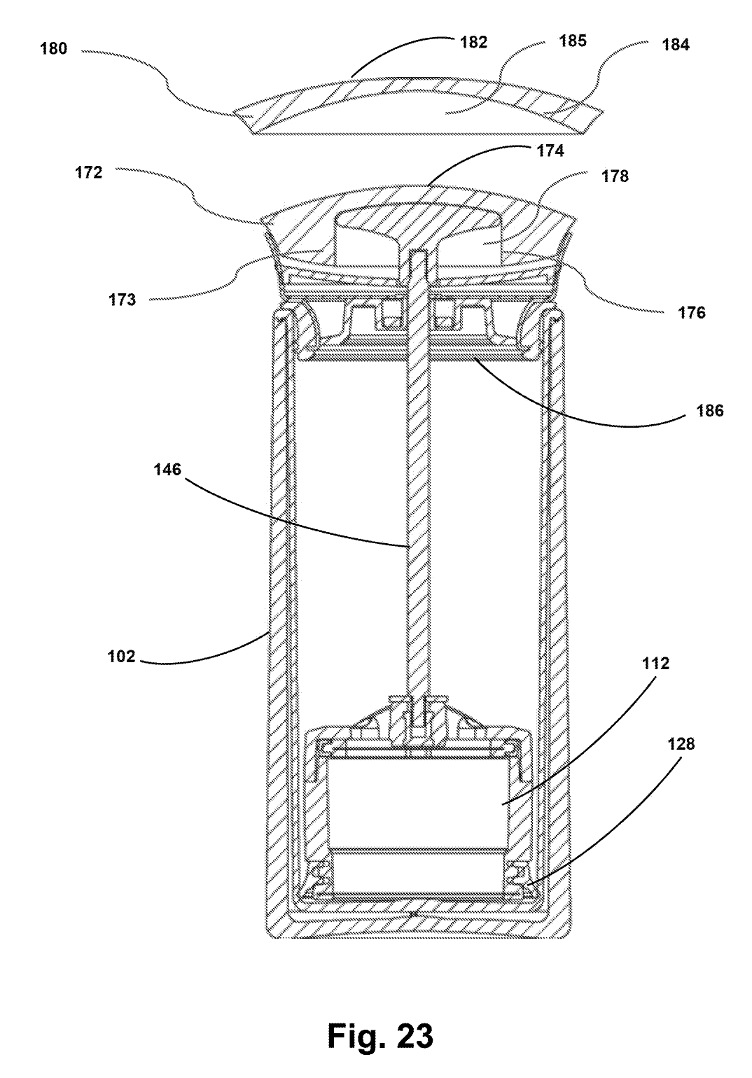

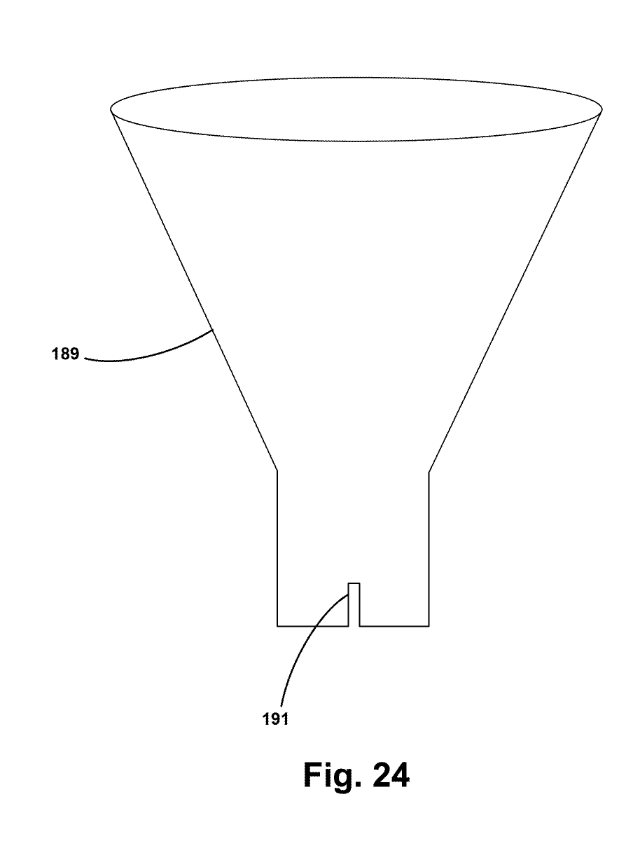

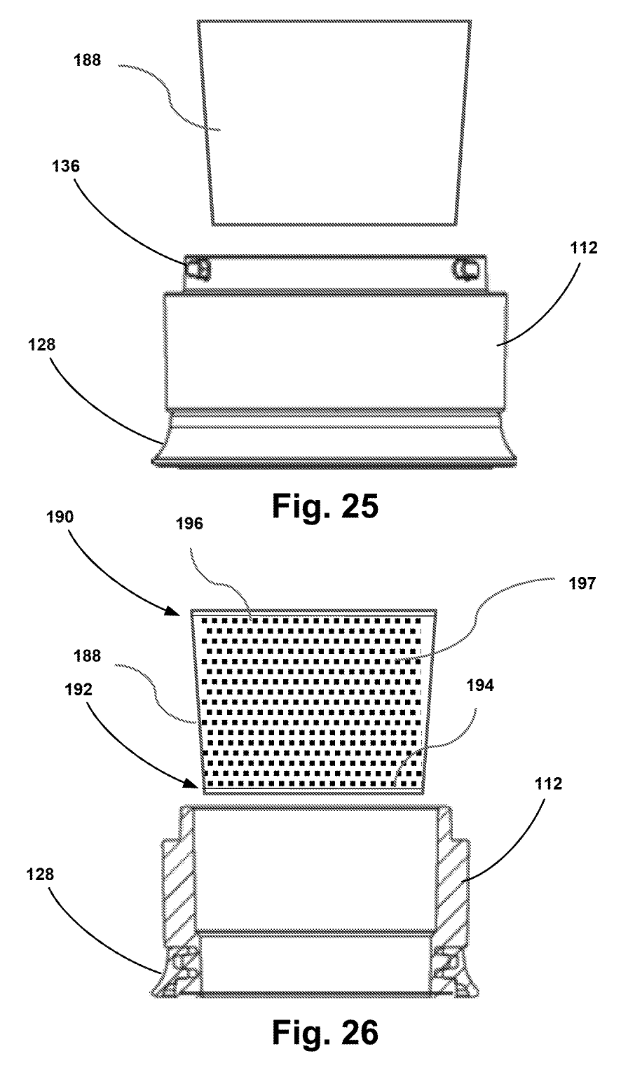

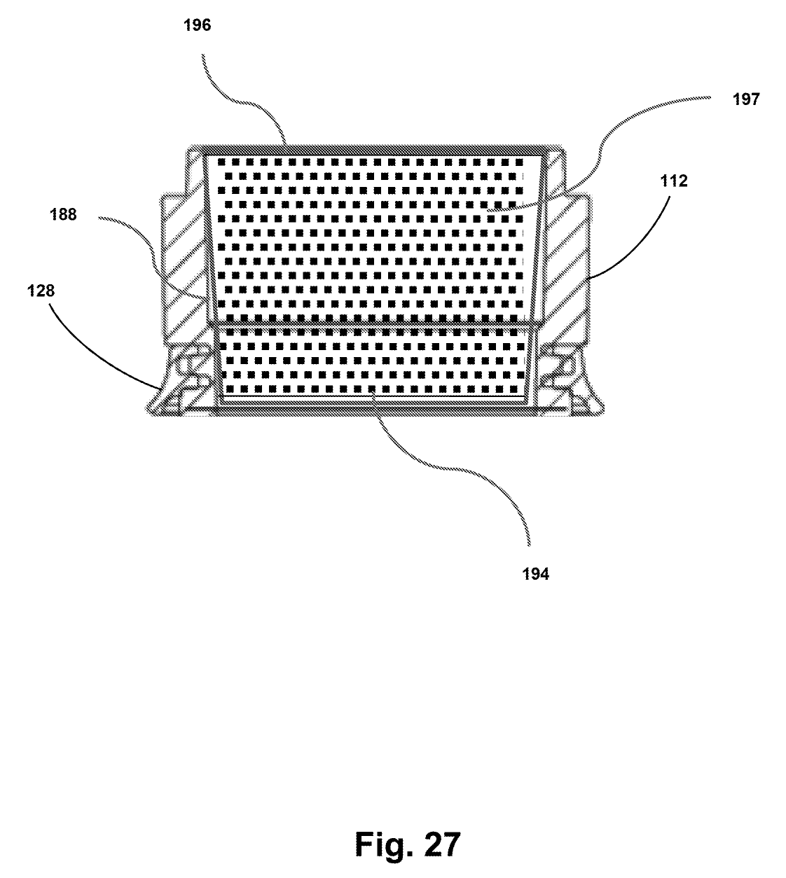

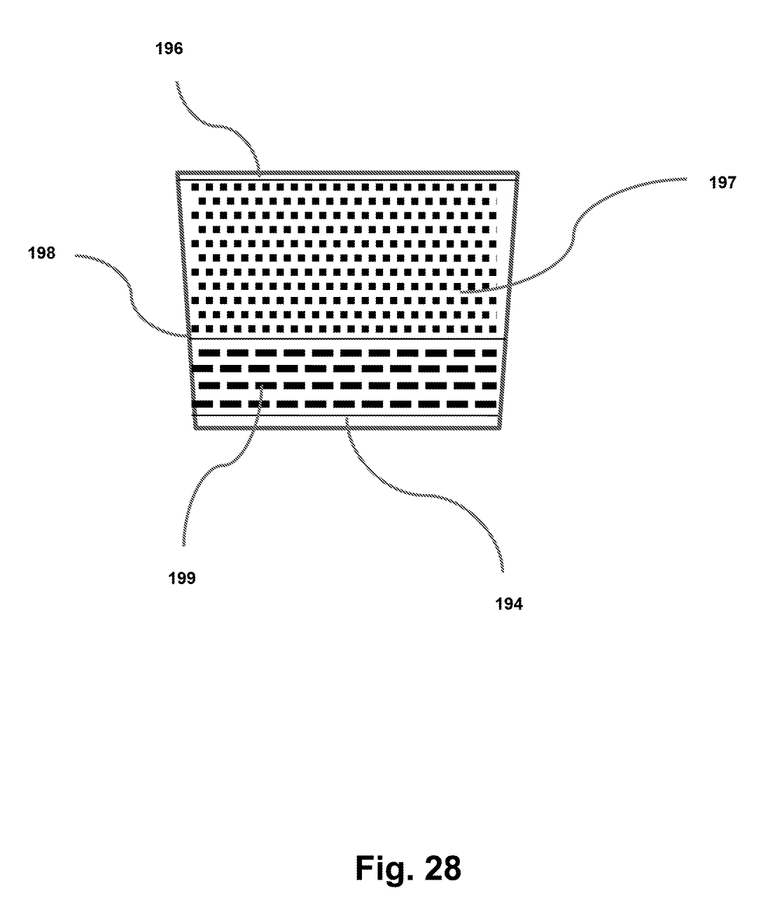

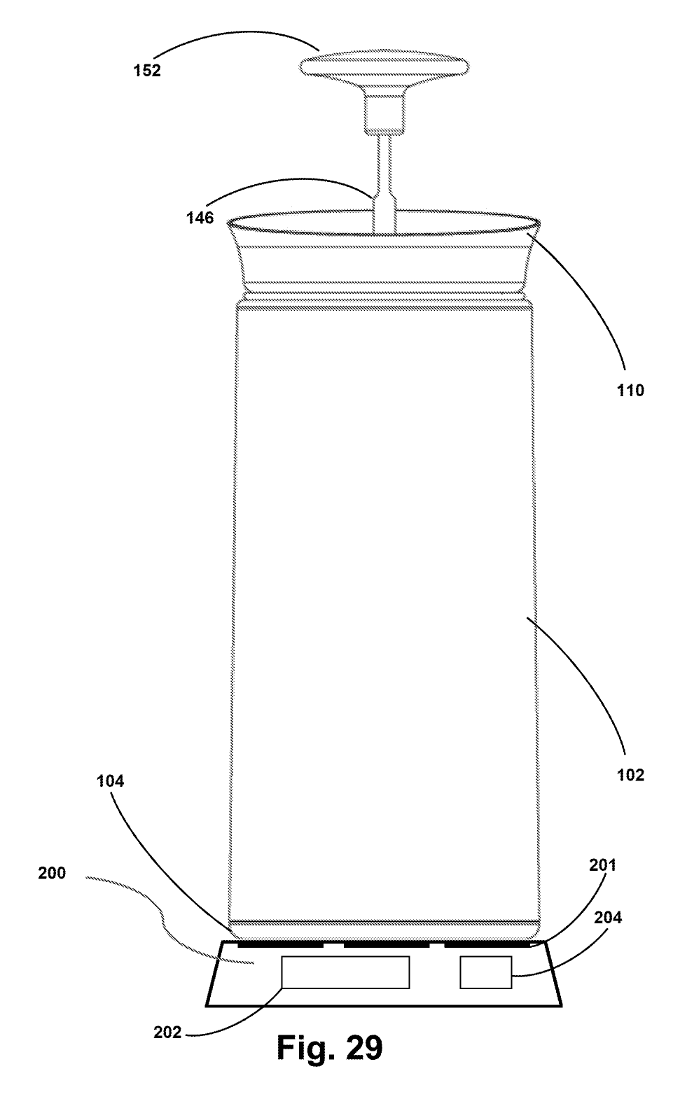

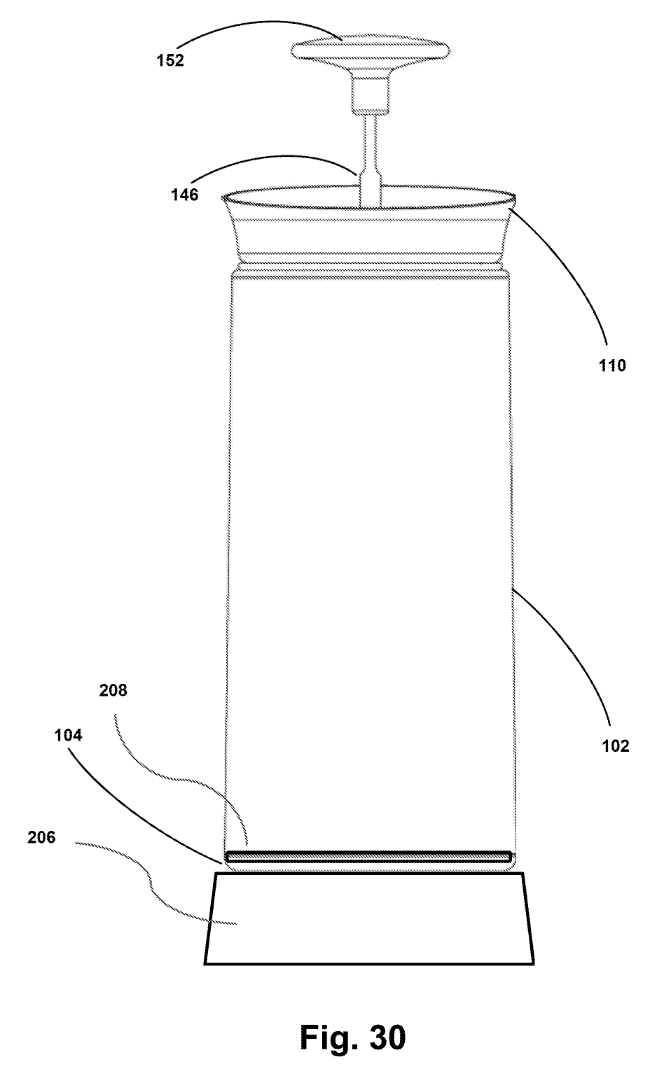

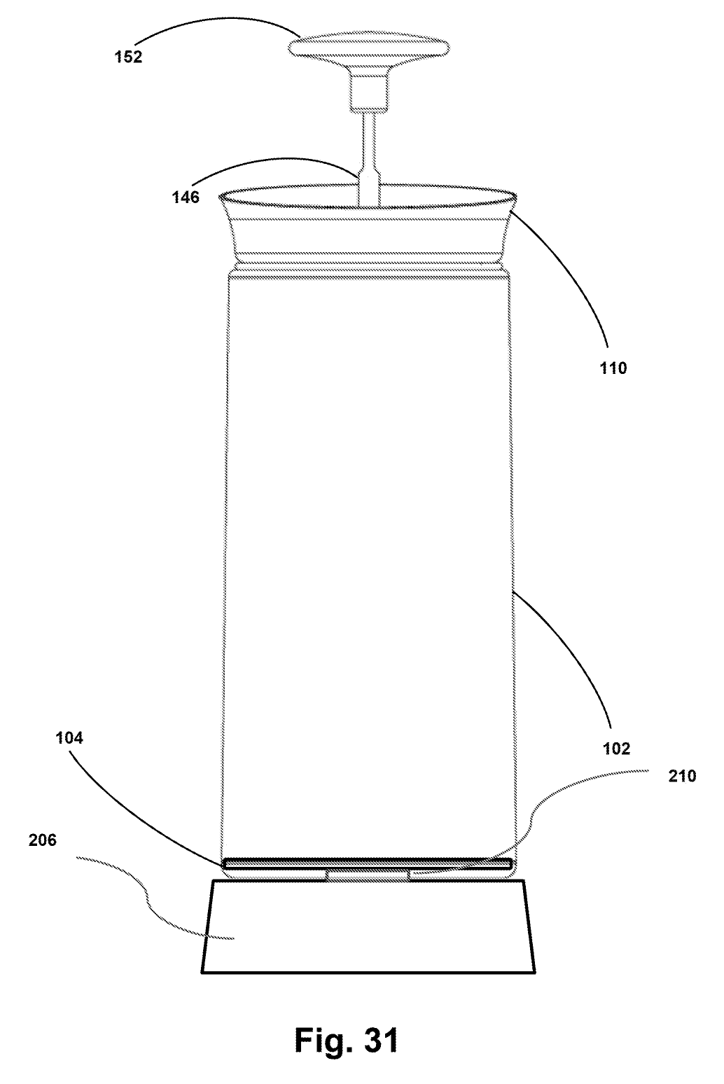

In one embodiment, as shown in FIGS. 1, 11, and 18-21, the apparatus 100 may further include a through-hole 144 positioned in the lid 110. The apparatus 100 may further include an elongated rod 146 positioned through the through-hole 144 and having a first end 148 and a second end 150. The first end 148 of the elongated rod 146 is removably coupled to the top 116 of the pod 112 via an attachment mechanism 147. The attachment mechanism 147 may be a threaded hole, and the first end 148 of the elongated rod 146 may be a complementary threaded rod. Other attachment mechanisms are possible as well. The apparatus 100 may further include a handle 152 coupled to the second end 150 of the elongated rod 146. In one example, a cross-section of the elongated rod 146 at the second end 150 is less than a diameter of the through-hole 144 in the lid 110.

The reduced cross section near the second end 150 of the elongated rod allows air to pass through the lid 100 of the apparatus 100 for preparing and pouring liquid solutions, where operation of the apparatus results in a change in the makeup of the original liquid. By allowing air to freely pass through the through-hole 144 and into the interior volume of the apparatus 100, smooth pouring of liquids directly from the apparatus 100 is allowed by preventing a partial vacuum that would otherwise form when flowing liquid occludes the pouring channel 154 during pouring. Furthermore, the lid 110 may further include a depression 156 surrounding the through-hole 144 and one or more stops 158 configured to prevent the handle 152 from blocking the through-hole 144 when the handle 152 is in a full-down position.

In the case of the embodiment shown in FIGS. 1, 11, and 18-21, the handle 152 may be metal and may become hot during preparation of hot beverages due to thermal bridging between a hot liquid (often required for brewing coffee or the like) and the handle 152 when the elongated rod 146 is of uniform cross section (an elongated rod 146 may be required to transmit the force needed to operate the apparatus 100 and is typically made of metal, a strong conductor of heat). Since hand contact is required with the handle 152 throughout the brewing process to operate the apparatus 100 and afterwards as well (to remove the pod 112 for cleaning and reuse) excessive heat transfer to the handle 152 is not desirable. The same may be true in cases where hand contact is required by excessive heat transfer is still an issue.

By reducing the upper cross section of the elongated rod 146 to allow for venting and smooth pouring of the apparatus 100, thermal bridging is also reduced. For a beverage preparation apparatus requiring reduced heat transfer to its handle 152, this prevents the contact point of the handle 152 becoming as hot as it would without the reduced thermal bridging unexpectedly created by the reduced cross section of the elongated rod 146 at the second end 150, which was intended only to improve pouring. Furthermore, in the case of heated extracting liquids, the same reduction in thermal bridging helps improve extraction of soluble compounds from a solute by better maintaining temperature of the heated extracting liquid and increasing the solubility of compounds in the relatively hotter extracting liquid.

Most coffee presses, carafes, etc. have a handle and a clearly protruding spout. In order to remove both handle and beak-like spout, and provide both aesthetic and functional advantages, a unique bottle design and “pouring edge” are required. By proving an both an interior wall 160 and an exterior wall 162 to the sidewall 106 of the container 102, an air gap is provided between the interior and exterior walls 160, 162 of the container 102 to allow for insulation from hot liquids contained in the container 102. By design, this insulation is not perfect, thus allowing users to feel the warmth of a hot beverage through the walls of the container 102 without being burned. Furthermore, by increasing the thickness and diameter of the exterior wall 162, the container 102 both takes on a unique aesthetic form and is easier to release from tooling. The cross-section of the sidewall 106 thus provides in one simple design an identifying silhouette, a wider base for stable pressing, an easy-to-hold exterior through which heat can be felt without being burned, and a design that may be easier to manufacture than a container with a lesser exterior draft.

Furthermore, the pouring edge 164 in combination with the pouring channel 156 and the lid 110 allow for smooth pouring without a traditional spout. The pouring edge 164 is sharp to reduce intermolecular adhesive forces between a fluid flowing out of pouring channel 156 during pouring and the pouring edge 164, while the shape of the pouring edge 164 encourages cohesive forces of a fluid flow, thus allowing for smooth pouring and preventing excessive formation of droplets that cause most spouts or pouring edges to form drips.

The operation of an apparatus consisting of an elongated rod 146 and a lid 110 may require that the lid 110 and elongated rod 146 be fastened together prior to operation, but then smoothly release during operation. The invention disclosed herein provides an alternative to a mechanical attachment that might otherwise require too much force to release, cost more to manufacture, or offer less value in terms of consumer appeal given the fanciful and desirable nature of magnets in the consumer market. In particular, in one embodiment a bottom surface 186 of the lid 110 includes a magnet 168, and the top 116 of the pod 112 includes a magnetic material 166 configured to removably couple the bottom surface 186 of the lid 110 to the top 116 of the pod 112. The magnet 168 exerts a magnetic force on the magnetic material 166 (e.g., a ferrous washer positioned on the top 116 of the pod 112) when the user operates the elongated rod 146 by drawing the handle 152 up and away from the lid 110). When sufficiently close, the magnet 168 engages with the magnetic material 166 causing the lid 110 and pod 112 to securely fasten together with enough force to resist the acceleration of gravity and some handling by a user without separating. The force is not so great, however, to prevent smooth release of the top 116 of the pod 112 from the lid 110 when pressed with a few pounds of force. This allows both easy handling of the elongated rod 146 and lid 110 as one piece when removed from the container 102, and easy operation of the apparatus 100 provided by a smooth release of the pod 112 from the lid 110 when downward force is applied to the handle 152 after the lid 110 and pod 112 are mounted in the container.

In the case that the handle 152 is made of a ferromagnetic material, the magnet 168 may also exert a force on the handle 152 to keep the two pieces fixed together when the handle 152 is close to the lid 110, thus fixing the lid 110 against the handle 152, allowing easy access to parts beneath the lid 110 without the lid 110 moving due to acceleration forces.

Additionally, compared to the brewing apparatus 100 described above in relation to FIGS. 1, 11, and 18-21 including the elongated rod 146 and handle 152, any of the brewing apparatuses 100 described above may simply employ the power of gravity to apply a force to the pod 112 and move it through the container 102, rather than a manually applied force to the handle 152.

The potential differences in grounds, which resist flow of water to varying degrees depending on grind fineness, roast type and other variables, poses a problem to controlling the rate at which water flows through the coffee, which is critical to a quality brew. The resistance to water flow of grounds is also non-linear with respect to time, as the grounds soak up more and more water and expands, thereby restricting flow of water. This requires that larger force of gravity be applied at first than is needed, so that there is enough force to complete transit of the pod 112 to the closed bottom 104 of the container 102, along with the ability to fine-tune speed so that the pod 112 moves neither too fast, nor too slow throughout the process. Such fine tuning of the speed of the pod 112 may be accomplished by providing adjustable mass weights 172, 180 so that the force gravity can be adjusted, and adjustable filters that resist water flow to varying degrees to control the speed of the apparatus 100 with a given applied force independently of the resistance of the grounds to water flow.

Additionally, to prevent the pod 112 becoming misaligned with the apparatus 100, some means of guiding the pod 112 throughout its transit is necessary. A means for extracting the pod 112 is also necessary, and the two may or may not be the same.

Further, the weights 172, 180 coupled to the pod 112 may need to be heavier than required to initiate brewing, as grounds or the like may soak up water and expand, thus restricting water flow more over time, while fines in ground coffee or the like may also clog the filter and even fill in spaces around larger grounds creating a semi-impermeable layer of bricks (large particles) and mortar (small particles) that may require a large mass to overcome. This presents a problem as such a large mass may tend to move too quickly at first, which may negatively impact the quality of a beverage, particularly cold brew, where a slow and steady movement of water through coffee grounds is desired over time.

FIGS. 22-23 illustrate a first embodiment of a gravity-powered pod 112 to address the issues discussed above. In particular, as shown in FIGS. 22-23, the apparatus 100 includes a weight 172 having a top surface 174 and a bottom surface 176. The weight 172 is removably positioned on the handle 152, and the bottom surface 176 of the weight 172 includes a cutout 178 complementary to the handle 152. The weight 172 allows the coffee containing pod 112 to be moved at a slow speed through the container 102 to create a cold brew coffee by applying a consistent force from the weight 172, rather than other means, such as the user pressing the handle 152 directly. Additionally, the weights 172, 180 with the correct mass and/or combination of filter 124 may move the pod 112 fast enough to produce a beverage utilizing hot or warm water as well.

As shown in FIG. 23, the cutout 178 is of complementary cross section to the handle 152 to allow the weight 172 to be compatible with the apparatus 100 described above. The shape of the weight 172 may be continued downwards 173 to add extra mass at a lower center of gravity for added stability. The same concepts can be applied to any shape of handle and lid for any type of coffee press or similar apparatus, so long as the shape allows for compatibility with the given apparatus and provides similar stability and clearance for all parts of any apparatus, including the apparatus described above.

In one example, the weight 172 comprises a first weight, and the apparatus further comprises a second weight 180 having a top surface 182 and a bottom surface 184. The second weight 180 is removably positioned on the top surface 174 of the first weight 172, and the bottom surface 184 of the second weight 180 includes a cutout 185 that is complementary to the top surface 174 of the first weight 172. As such, the second weight 180 may be designed to fit over the first weight 172 with their complementary shapes. In such an example, bottom surface 176 of the first weight 172 and/or the bottom surface 184 of the second weight 180 may include a high friction surface to better maintain a stable position. These features may be advantageous as a weight without some or all of these features may be prone to fall off a given apparatus before completing a brewing cycle. Additionally, the concept of “nesting” weights as shown with the first weight 172 and the second weight 180 can be repeated with any number of additional weights designed to fit securely over their base weight or base apparatus, designed to fit inside as internally nesting weights in any configuration, designed to attach magnetically or mechanically, or by any means that secures the weights to the apparatus while allowing for them to be added or removed. For clarification, all principles of nesting or modular weights can be applied to a single weight as well.

In the embodiment shown in FIGS. 22-23, the elongated rod 146 of the brewing apparatus serves both to transmit force to the pod 112 from applied weights 172, 180, can contribute to total mass, and may also serve to maintain proper alignment of the pod 112 throughout transit from top to bottom, and also allows for easy extraction of the pod 112 after brewing, at a cost of increased height of the brewing apparatus 100 at the beginning of a brewing cycle.

Another gravity powered pod embodiment can be used with the pod 112 shown in FIGS. 12-15. The gravity powered embodiment using the pod 112 as shown in FIGS. 12-15 works on similar principles to the embodiment shown in FIGS. 22-23, by applying a force to the pod 112 from a weight or mass (rather than other means), but the mass is provided by the body of the pod 112 itself and/or by other parts in combination to achieve the total desired mass, rather than by externally applied weights. However, the core concepts of both embodiments can be combined by removing the elongated rod 146 of the embodiment shown in FIGS. 22-23 to achieve a “free falling” effect and to achieve the added advantage of a more compact brewing device able to more easily fit in a refrigerator for cold brewing, under countertops, or any confined space where the elongated rod 146 may present a clearance issue, while adding the variable weights of the embodiment shown in FIGS. 22-23, to be applied either by a shortened elongated rod 146 or directly to the pod 112. Furthermore, the elongated rod 146 can still be used in conjunction with the pod 112 shown in FIGS. 12-15 as a removable accessory an attachment means, to allow easier extraction of the pod 112 or to make adjustments during brewing after the pod 112 has been released into the bottle by mechanical, user, or other means.

In the embodiment shown in 12-15, a mass moves a coffee, tea, or the like containing pod 112 by force of gravity through a water (or other extracting liquid) container 102 to create cold or hot brew coffee or other beverage. Depending on the relationship of between drag forces, all of which can be tuned by design of the pod's and/or filters' hydrodynamic drag, friction, or similar drag forces from the coffee grounds or similar substance, which vary depending on what substance to be extracted that a user selects to dispose in the pod, as well as the quantity of substance, and the amount of mass applied to the construction of the pod body, top and other components, which correlates to the amount of force applied and, with respect to basic kinematics, determines the rate at which the pod moves through the carafe, which is a key variable in determining the type and quality of brewed beverage.

The gravity concept as described above can also be applied to other types of presses using the same core concept of complementary underside cross-sections, non-slips surfaces, etc. to hold weights in place, plus calibration features (nesting weights and/or brake filters, etc.) to allow users to fine-tune plunging speed for hot or cold brew, especially with respect to French press designs.

In one embodiment, the gravity powered concept may be combined with a timing/release mechanism to allow automatic plunging of the brewing apparatus described herein, a French press, AeroPress, or any other type of coffee press. In particular, in embodiments where the top 116 of the pod 112 is configured to be removably attached to a bottom surface 186 of the lid 110 prior to use, the apparatus 100 may further include a release mechanism configured to release the pod 112 from the bottom surface 186 of the lid 110 during use. Such a release mechanism may comprise a latch and lever system configured to release the pod 112 from the bottom surface 186 of the lid 110. In another example, the release mechanism may comprise a latch configured to provide a few pounds of force to separate a magnetic connection between the top 116 of the pod 112 and the bottom surface 186 of the lid 110. Other release mechanisms are possible as well.

In yet another embodiment, as shown in FIG. 24, the brewing apparatus 100 may include a funnel 189 designed to mate with the pod 112 by having a plurality of receiving grooves 191 of the same orientation of the plurality of fasteners 134 of the pod 112. The grooves 191 in the funnel 189 may be straight grooves sized to provide enough friction so a funnel of any design can simply be press fit on top of the pod 112 with no actual locking, then pulled off. In such an example, simple friction provides an easily attachable and releasable fixture merely by press-fitting the funnel 189 then pulling it off, but also provides enough friction that the assembly could be held upside down or otherwise handled without the funnel 189 falling off. Other attachment mechanisms between the pod 112 and the funnel 189 are possible as well. The funnel 189 may provide an easier way to pour coffee grounds into the pod 112, as an example.

Disposable cartridges that are positionable in the pods 112 may offer an advantage over loose filling of coffee in terms of convenience, both during setup and cleanup, but may also offer a unique advantage for coffee made from the apparatus 100 described herein, as issues caused by incorrect grinds size, excessive fines, etc. can be controlled before the coffee reaches the consumer, ensuring that they have an excellent experience by removing otherwise uncontrollable variable when the consumer sources (and possibly grinds) their own coffee.

Thus, in one example as shown in FIG. 25, the apparatus 100 may include a disposable cartridge 188 configured to be positioned in the pod 112, where the disposable cartridge includes ground coffee or tea. In one example, the disposable cartridge 188 has a cross-section at a top 190 of the cartridge 188 that is wider than a cross-section at a bottom 192 of the cartridge 188. In another example, the disposable cartridge 188 has a cross-section at a bottom 192 of the cartridge 188 that is wider than a cross-section at a top 190 of the cartridge 188. In yet another example, the cross-section of the disposable cartridge 188 is substantially uniform. Further, the disposable cartridge 188 may be complementary to the associated reusable pod 112 in which the disposable cartridge 188 is designed to be placed.

As shown in FIG. 26, the disposable cartridge 188 may include an inlet filter 194 positioned at the bottom 192 of the disposable cartridge 188 and an outlet filter 196 positioned at the top 190 of the disposable cartridge 188. The relative porosity between the inlet filter 194 and the outlet filter 196 may be varied to control resistance to the flow of water and backpressure. In one particular example, the inlet filter 194 of the disposable cartridge 188 has a higher porosity than the outlet filter 196 of the disposable cartridge 188, to thereby impose a pressure on a liquid as it passes through the disposable cartridge 188. The inlet filter 194 allows water in while retaining grounds inside the pod 112, and the outlet filter 196 allows brewed coffee or other infusions to flow out while allowing ground coffee 197 or other solute contained in the pod 112 (such as tea or ground roasted cocoa beans) to be retained in the pod 112.

FIG. 27 shows the disposable cartridge 188 placed in the reusable pod 112, after which the reusable pod 112 can be attached to the elongated rod 146 and used to brew without added steps. There is no need to pierce the disposable cartridge 188 or require other modifications to make the disposable cartridge 188 compatible with the device described herein, as filters 194, 196 allow the flow of water. Exterior packaging, such as vacuum wrapping or removable and disposable foil or similar seals adhered over filters 194, 196 can be added to retain freshness.

Alternatively, another embodiment with non-removable seals can be used, thus requiring a modification to the existing brewing apparatus to pierce non-removable seals when the disposable cartridge 188 is placed in the reusable pod 112 and/or when the reusable pod 112 is attached to the elongated rod 146, for example.

Another alternative embodiment can include any number of one or more additional membranes, baffles barriers or filters to segment the interior of the pod into more than one volume. This can be done to cause turbulence in the pod 112 to increase agitation, to improve water flow for even extraction, to allow for separate extraction phases or solutes, etc.

In the embodiment illustrated in FIG. 28, the disposable cartridge 188 includes a membrane 198 positioned between the inlet filter 194 of the disposable cartridge 188 and the outlet filter 196 of the disposable cartridge 188. The membrane 198 separates extractable solute 197 from activated charcoal 199, thus allowing removal of certain substances from brewing water before the brewing water reaches extractable solute 197 to improve taste and safety.

Any combination of substances and interior volume segmentation can be used to alter the flow of water through the pod and/or to alter the resulting beverage.

In another embodiment, as shown in FIG. 29, the brewing apparatus 100 described herein may include a base 200 removably coupled to the closed bottom 104 of the container 102. The base 200 may include one or more force sensors 201. The base 200 allows a standard brewing apparatus 100 to be turned into a “smart” or “connected” product by building electronics into the base 200 that are capable of storing, displaying or outputting data from internals sensors. The base 200 may further includes a display 202 to provide a visual display of an amount of force applied to the container 102. The base 200 may also include a wireless communication interface configured to transmit a determined amount of force applied to the container 102 to a computing device, such as a smartphone or tablet device. The base 200 may further include a timer 204. In one example, the timer 204 is integral to the display 202.

The base 200 may include additional sensors in addition to the one or more force sensors 201. The sensors can be used to measure coffee and water dosing as a typical scale would do, but also to measure time and pressure of pressing simply by placing the apparatus 100 on the base 200 after using it as a traditional scale for measuring dosing. Once placed on the base 200, the scale can be turned into a smart device by sensing a force greater than the pre-programmed weight of the apparatus 100 plus the previously measured water and coffee masses. This would be the force of a user pressing the press and recognizable to the system by such simple mathematics. Such a measurement can initiate a log of forces applied relative to time, and outputs either on the device, stored to the device, or transmitted to other devices such as smart phones, can be used to aid the user in precisely timing their pressing and precisely applying the desired amount of pressure, including additional complications, such as pre-infusion timing and pressing time.

For the example of pre-infusion timing, the base 200 can sense initiation of pre-infusion through the added forces required to press the pod 112 into the water (the typical method of pre-infusion for the apparatus 100) followed by sensing and logging the end of pre-infusion by the removal of those loads from the scale. The base 200 can than begin a pre-set or programmable timer 204 to alert the user when to begin pressing again, and can then guide the user to apply the correct amount of pressure through force data displayed on the device or externally, or guide speed through timing data displayed on the device or externally with the addition of a graphical guide on smart phones to show a real-time graphic of relative position of the plunger to the carafe for an ideal brew.

Any combination of sensors that can be built into the base and used without modifying the existing apparatus 100, as well as any combination of data display can be used, including temperature sensors. Alternatively, sensors can be built into an alternative embodiment of the apparatus 100 itself, and either work independently or communicate with the base 200. The base 200 is also capable of receiving data from the cloud, other bases, etc. to allow users to share and replicate recipes.

In the example shown in FIG. 30, the apparatus 100 includes a heating base 206 removably coupled to the closed bottom 104 of the container 102. The heating base 206 is configured to heat a liquid positioned in the container 102. The heating base 206 may comprise adding an induction heating element 208 to base 200, or can be used as a standalone embodiment simply to provide heating in combination with induction element 208, which receives a magnetic field from heating base 206, thus inducing a current to flow in induction element 208 resulting in heat energy that can then be transferred to the container 102 and any liquids contained in it.

In this manner, water can be heated and kept hot for brewing in the container 102 without the need for water to be heated externally. Additionally, the induction element 208 can be placed anywhere in the container 102 close enough to receive the magnetic field effectively, or used in combination with other heating elements, to aid in heating water as well as keeping a brewed beverage warm, such as at a set temperature programmed by the user, or pre-programmed in the case of adding these features to base 200.

In another embodiment, as shown in FIG. 31, the heating base 206 passes electrical energy via physical contacts rather than magnetic fields by connecting a heating element in the carafe via a connection 210 to the electrical supply in heating base 206.

In another example, heating elements can be placed on top of the pod 112 of the standard brewing apparatus 100 to create a pod top 116 that is capable of receiving current from connection 210 after being passed through leads in the pod 112 and to a heating element on top 116 of the pod 112 to allow better heating of already brewed beverages to maintain them at the desired temperature as determined by standard practices or customizable programming. The heating base 206 as described in relation to FIGS. 30 and 31 may be combined with the base 200 described in relation to FIG. 29, such that one or more of the elements described above are included in a single base.

FIG. 32 illustrates an example schematic drawing of a computer network infrastructure. In one system 600, a computing device 602 communicates with the one or more force sensors 201 of the base 200 using a communication link 604, such as a wired or wireless connection. The computing device 602 may be any type of device that can receive data and display information corresponding to or associated with the data. For example, the computing device 602 may be a mobile phone, a tablet, or a personal computer as examples.

Thus, the computing device 602 may include a display system 606 comprising a processor 608 and a display 610. The display 610 may be, for example, an optical see-through display, an optical see-around display, or a video see-through display. The processor 608 may receive data from the one or more force sensor 201, and configure the data for display on the display 610. Depending on the desired configuration, processor 608 can be any type of processor including, but not limited to, a microprocessor, a microcontroller, a digital signal processor, or any combination thereof

The computing device 602 may further include on-board data storage, such as memory 612 coupled to the processor 608. The memory 612 may store software that can be accessed and executed by the processor 608, for example. The memory 612 can include any type of memory now known or later developed including but not limited to volatile memory (such as RAM), non-volatile memory (such as ROM, flash memory, etc.) or any combination thereof

According to an example embodiment, the computing device 602 may include program instructions that are stored in the memory 612 (and/or possibly in another data-storage medium) and executable by the processor 608 to facilitate the various functions described herein. Although various components of the system 600 are shown as distributed components, it should be understood that any of such components may be physically integrated and/or distributed according to the desired configuration of the computing system.

The one or more force sensor 201 and the computing device 600 may contain hardware to enable the communication link 604, such as processors, transmitters, receivers, antennas, etc.

In FIG. 32, the communication link 604 is illustrated as a wireless connection; however, wired connections may also be used. For example, the communication link 604 may be a wired link via a serial bus such as a universal serial bus or a parallel bus. A wired connection may be a proprietary connection as well. The communication link 604 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

FIG. 33 is a block diagram of an example method for brewing coffee or the like. Method 700 shown in FIG. 33 presents an embodiment of a method that could be used by the apparatus 100 of FIGS. 1-32, as an example. Method 700 may include one or more operations, functions, or actions as illustrated by one or more of blocks 702-710. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

Initially, at block 702, the method 700 includes filling the container of the apparatus 100 of any one of the embodiments described above with a liquid. At block 704, the method 700 includes positioning ground coffee or tea in the pod 112. At block 706, the method 700 includes positioning the pod 112 in the open top 108. At block 708, the method 700 includes positioning the lid 110 over the open top 108. At block 710, the method 700 includes moving the pod 112 through the liquid until the pod 112 is positioned on the closed bottom 104 of the container 102, such that the liquid is forced through the first filter 120, through the ground coffee or tea, and out of the second filter 124, to produce brewed coffee or tea in the volume of the container 102 above the pod 112. As discussed above, the pod 112 may be moved through the container 102 via a handle 152 and elongated rod 146, or may be moved through the container 102 via gravity. In this plunging process, the resistance to fluid flow created by the second filter 124 will control the resistance the user experiences while plunging and thus the rate at which the user plunges for a given plunging force. This affects the final brew characteristics by varying the time of plunging and thus the time of brewing.

The beverage may then be consumed directly from the container by removing the lid 110 or it may be poured into another container, such as a coffee cup, for consumption.

As discussed above, the production of coffee requires contact time that is tied to the temperature of the extracting water. If the temperature of the water is high, contact time can be short. If the temperature of the extracting water is low, coffee can still be brewed, but for room temperature or colder water, it may take hours, rather than minutes. This type of brewing is called “cold brew”, often noticed for its “smooth” flavor and lower acidity, and is purported to be a healthier option to traditionally brewed coffee as a result. This means providing a controlled rate of flow of water through coffee grounds for a long period of time, often accomplished by slowly dripping water onto grounds from a reservoir.

A unique aspect of the brewing apparatuses 100 described herein is that the coffee is moved through the water, rather than moving the water through the coffee, and the rate of flow is controlled by the force of gravity applied to the apparatus 100, rather than by a valve or simple diffusion, as is the case with preparing cold brew in a French press.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense. Further, it is intended to be understood that the following clauses (and any combination of the clauses) further describe aspects of the present description.

1. An apparatus comprising:
a container having a closed bottom, a sidewall extending away from the closed bottom, and an open top;
a lid configured to be removably positioned over the open top of the container;
a pod having a bottom and a top spaced apart by a pod sidewall, wherein the bottom of the pod includes a first filter including a first plurality of openings, wherein the top of the pod includes a second filter including a second plurality of openings, wherein the top of the pod is removable to allow ground coffee or tea to be disposed in the pod between the first filter and the second filter; and
a seal coupled to an exterior of the pod, wherein an outer diameter of the seal is complementary to an inner diameter of the sidewall of the container.

2. The apparatus of claim 1, wherein the open top has an inner diameter substantially equal to an inner diameter of the closed bottom.

3. The apparatus of claim 1, wherein the open top has an inner diameter that is greater than an inner diameter of the closed bottom.

4. The apparatus of claim 1, wherein the open top has an inner diameter that is smaller than an inner diameter of the closed bottom.

5. The apparatus of claim 1, wherein the second filter includes a rigid outer frame coupled to an outer edge of the second filter and a gasket coupled to an outer edge of the rigid frame.

6. The apparatus of claim 1, wherein the top of the pod is removably coupled to the pod via a threaded connection.

7. The apparatus of claim 1, wherein an outer surface of the pod includes a plurality of fasteners projecting away from the outer surface, and wherein the top of the pod includes a plurality of indentations configured to receive the plurality of fasteners to thereby removably couple the top of the pod to the pod.

8. The apparatus of claim 1, wherein the top of the pod is removably coupled to the pod via a press fit.

9. The apparatus of claim 1, wherein the second filter is removably coupled to the top of the pod via a press fit.

10. The apparatus of claim 1, wherein the seal is coupled to the exterior of the pod at the bottom of the pod.

11. The apparatus of claim 1, wherein the seal is coupled to the exterior of the pod at the top of the pod.

12. The apparatus of claim 1, wherein the seal comprises a first seal, wherein the first seal is coupled to the exterior of the pod at the bottom of the pod, and wherein the apparatus further comprises a second seal coupled to the exterior of the pod at the top of the pod, wherein an outer diameter of the second seal is complementary to the inner diameter of the sidewall of the container.

13. The apparatus of claim 1, wherein the first filter has a higher porosity than the second filter, to thereby impose a pressure on a liquid as it passes through the pod.

14. The apparatus of claim 13, wherein the first plurality of openings of the first filter are greater in number than the second plurality of openings in the second filter.

15. The apparatus of claim 13, wherein at least some of the first plurality of openings of the first filter have a greater diameter than at least some of the second plurality of openings of the second filter.

16. The apparatus of claim 1, wherein the second filter is adjustable by a user to thereby adjust a porosity of the second filter.

17. The apparatus of claim 1, wherein each of the first plurality of openings of the first filter has a longitudinal axis that is substantially parallel to a longitudinal axis of the container.

18. The apparatus of claim 1, wherein one or more of the first plurality of openings of the first filter has a longitudinal axis that is angled with respect to a longitudinal axis of the container.

19. The apparatus of claim 1, wherein a first opening of the first plurality of openings of the first filter has a longitudinal axis that is angled with respect to a longitudinal axis of a second opening of the first plurality of openings of the first filter.

20. The apparatus of claim 1, wherein each opening of the first plurality of openings of the first filter is positioned on one portion of the first filter.

21. The apparatus of claim 1, wherein a length of the pod sidewall separating the bottom of the pod from the top of the pod is adjustable by a user.

22. The apparatus of claim 1, wherein the seal includes an outwardly extending flange and a cutout portion between the outwardly extending flange and the pod sidewall.

23. The apparatus of claim 1, further comprising:
a through-hole positioned in the lid;
an elongated rod positioned through the through-hole and having a first end and a second end, wherein the first end of the elongated rod is removably coupled to the top of the pod; and
a handle coupled to the second end of the elongated rod.

24. The apparatus of claim 23, wherein a cross-section of the elongated rod at the second end is less than a diameter of the through-hole in the lid.

25. The apparatus of claim 23, wherein the lid further includes a depression surrounding the through-hole and one or more stops configured to prevent the handle from blocking the through-hole when the handle is in a full-down position.

26. The apparatus of claim 23, wherein a bottom surface of the lid includes a magnet, and wherein the top of the pod includes a magnetic material configured to removably couple the bottom surface of the lid to the top of the pod.

27. The apparatus of claim 23, further comprising a weight having a top surface and a bottom surface, wherein the weight is removably positioned on the handle, and wherein the bottom surface of the weight includes a cutout complementary to the handle.

28. The apparatus of claim 27, wherein the weight comprises a first weight, the apparatus further comprising a second weight having a top surface and a bottom surface, wherein the second weight is removably positioned on the top surface of the first weight, and wherein the bottom surface of the second weight is complementary to the top surface of the first weight.

29. The apparatus of claim 1, further comprising a brake filter having one or more openings removably positioned adjacent the second filter at the top of the pod.

30. The apparatus of claim 29, wherein at least one of the one or more openings of the brake filter are adjustable by a user.

31. The apparatus of claim 1, wherein the top of the pod is configured to be removably attached to a bottom surface of the lid prior to use, and wherein the apparatus further includes a release mechanism configured to release the pod from the bottom surface of the lid during use.

32. The apparatus of claim 1, further comprising a funnel removably coupled to the pod sidewall.

33. The apparatus of claim 1, further comprising a disposable cartridge positioned in the pod, wherein the disposable cartridge includes ground coffee or tea.

34. The apparatus of claim 33, wherein the disposable cartridge has a cross-section at a top of the cartridge that is wider than a cross-section at a bottom of the cartridge.

35. The apparatus of claim 33, wherein the disposable cartridge has a cross-section at a bottom of the cartridge that is wider than a cross-section at a top of the cartridge.

36. The apparatus of claim 33, wherein the disposable cartridge includes an inlet filter positioned at a bottom of the cartridge and an outlet filter positioned at the top of the cartridge.

37. The apparatus of claim 36, wherein the inlet filter of the disposable cartridge has a higher porosity than the outlet filter of the disposable cartridge, to thereby impose a pressure on a liquid as it passes through the disposable cartridge.

38. The apparatus of claim 36, further comprising a membrane positioned between the inlet filter of the disposable cartridge and the outlet filter of the disposable cartridge.

39. The apparatus of claim 1, further comprising a base removably coupled to the closed bottom of the container, wherein the base includes one or more force sensors.

40. The apparatus of claim 39, wherein the base includes a display to provide a visual display of an amount of force applied to the container.

41. The apparatus of claim 39, wherein the base includes a wireless communication interface configured to transmit a determined amount of force applied to the container to a computing device.

42. The apparatus of claim 39, wherein the base includes a timer.

43. The apparatus of claim 1, further comprising a heating base removably coupled to the closed bottom of the container, wherein the heating base is configured to heat a liquid positioned in the container.

44. A method comprising:
filling the container of the apparatus of claim 1 with a liquid;
positioning ground coffee or tea in the pod;
positioning the pod in the open top;
positioning the lid over the open top; and
moving the pod through the liquid until the pod is positioned on the closed bottom of the container, such that the liquid is forced through the first filter, through the ground coffee or tea, and out of the second filter, to produce brewed coffee or tea in the volume of the container above the pod.
